(19) United States
(12) Patent Application Publication
(10) Pub. No.: US 2013/0305147 A1
(43) Pub. Date: Nov. 14, 2013

(54) DATA PROCESSING SYSTEM FOR EVENT PRODUCTION MANAGEMENT

(71) Applicants: David Joseph McBride, Tempe, AZ (US); Tandy Amber Stepp, Tempe, AZ (US)

(72) Inventors: David Joseph McBride, Tempe, AZ (US); Tandy Amber Stepp, Tempe, AZ (US)

(73) Assignee: PIXEL PERFECT LLC, Tempe, AZ (US)

(21) Appl. No.: 13/859,602

(22) Filed: Apr. 9, 2013

Related U.S. Application Data
(60) Provisional application No. 61/686,798, filed on Apr. 13, 2012.

(51) Int. Cl. G06F 17/24

(52) U.S. Cl. CPC G06F 17/24
USPC 715/256; 715/273

(57) ABSTRACT

One embodiment of a data processing system for generating and managing a plurality of event production documents. The data processing system comprising a computing device operating a software application and connecting to a plurality of tablet computing devices over a network. The event production documents comprising show flows for managing event productions. The show flow comprising a plurality of predetermined columns and rows, or cues. The data processing system comprising a plurality of modes for designing, rehearsing and executing the event production. Cues are able to be added, removed or edited in real-time. The plurality of predetermined cues and timers are automatically updated based on predetermined logic functions associated with a plurality of classifications of cues. Advancing cues shares associated real-time updates with connected computing devices operating a companion application. Users are able to create, edit and save private notes using the companion application. Other embodiments are described.

### CROSS-REFERENCE TO RELATED APPLICATIONS

This application claims the benefit of provisional patent application Ser. No. 61/686,798 filed 2012 Apr. 13 by the present inventors.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Prior Art

The following is a tabulation of some prior art that presently appears relevant:

U.S. Patents

| Patent Number | Issue Date | Applicant | Title |
|---|---|---|---|
| EP2002359 A1 | Dec. 17, 2008 | Google, Inc. | Collaborative online |
| | | | spreadsheet application |
| U.S. Pat. | Apr. 25, 2000 | Microsoft | Computerized |
| No. 6,055,548 | | Corporation | spreadsheet with |
| | | | auto-calculator |
| EP0172260 A1 | Feb. 26, 1986 | William P. | Countdown Timer |
| | | Ketcham | |

### BACKGROUND AND PRIOR ART

The live event production industry includes but is not limited to corporate meetings, events, theater productions, broadcast productions, web casts, fashion shows, parades, political speeches, religious sermons, ceremonies, weddings, inaugurations, conventions, awards shows, press conferences, presentations, demonstrations, classes, product announcements, auctions, music concerts, circus acts, comedy shows, dance recitals and other shows or event productions.

Generally, shows are managed, operated and/or produced by a team of people, herein referred to as the production team. In the case of corporate event shows, the leader of said production team is the Producer and/or Stage Manager.

The Stage Manager of the show is generally responsible for designing an event production document, commonly referred to as a “Show Flow”, “Run of Show”, “Rundown”, “Cue Sheet”, “Cue-to-Cue”, “Que-to-Que”, “Minute-by-Minute”, “Script”, “Prompt Book”, “Show Bible”, “Cue Book”, “Schedule of Events”, “Production Schedule”, “Production Sequence of Events”, “Timeline” or other event production documents, and to communicate said show flow to the members of the production team.

The current industry-adopted format for a show flow is generally a spreadsheet or document comprising of a series of consecutive cue numbers along one axis and labels or headers along the other axis including but not limited to: “Cue Start Time”, “Duration”, “Action/Description/Script/Element/Function”, “Team Member/Operator/Position/User” and “Notes/Comments”.

Cues refer to an action or series of actions that are to be executed at a specific time and order in the show. For instance, when a presenter is to enter the stage from back stage they would get a “standby” cue to get ready and wait before entering followed by a “go” cue to then enter the stage. Cues can be as simple as turning on a light or music to very complex cues involving pyrotechnics and choreographed movements of a plurality of team members.

The current industry standard method for producing and distributing the show flow comprises of the Stage Manager creating the show flow in Microsoft Excel or Microsoft Word, for example, printing the spreadsheet or document using a computer and printer, and then distributing paper copies to the production team. There are many challenges with the presently adopted method.

During the developmental stages of the show flow, especially in the rehearsal of the live event or show, many changes to the show flow may be necessary. As cues are added, removed, moved or edited, each team member writes down notes on their paper copy. If the Stage Manager has time, they may update the spreadsheet or document and redistribute a new paper copy of the show flow to the production team. If the individual team members had their own unique hand-written notes on their own paper copy of the show flow, they would have to carefully rewrite their notes on the new printed version since the individual or “Private Notes” are not generally updated by the Stage Manager on the revised printed copies of the show flow. The process of revising, reprinting and redistributing paper copies of the Show Flow may be repeated many times. If changes to the show flow are necessary during the actual show, the Stage Manager generally makes an announcement over headset to the production team members and then each team member writes down the changes on their existing printed copy of the show flow.

If important cue notes are not properly transcribed to each current version of the show flow or are not communicated by the Stage Manager, human error on the part of the production team may ensue, potentially causing disruptions or failures of the various elements of the show including but not limited to incorrect, delayed or missed cues such as rolling videos, turning on the microphone of the guest speaker, operating a lighting effect, playing audio tracks, changing the graphics on the screens, set changes, opening or closing the curtains, turning on house lights, igniting pyrotechnics etc.

The current industry standard for speaker timers is generally a small box controller that sends a signal down a wire to a display which is placed in a position that people on the stage can view or in a green room or backstage. The currently used speaker timers are cumbersome and outdated. They are stand-alone countdown timers and can have no outside control. Generally, there is not a specific person assigned to set and manage the speaker timer so a production crew member who is already assigned to another technical position is often recruited to increase their work load and also manage the speaker timer during the show which results in the technician often forgetting to set the speaker timer or often starting the timer late or not at all.

During the show, it is common for multiple crew members, clients, actors and presenters to ask whoever is running the speaker timer, “how much time do we have left?”. This also leads to other questions like “what cue are we on?”, and “where are we in the show flow?” Often presenters or actors are confused as to when they are supposed to be out on stage. Other event professionals such as banquet kitchen staff, event vendors, destination management companies, limo drivers and meeting planners may also need to know if the event production is on time, ahead of schedule or behind schedule to manage the connected elements of the overall event. If the overall event production elements are not cohesively orchestrated, additional labor and costs associated with time may be incurred.

### BRIEF SUMMARY OF THE INVENTION

In accordance with one embodiment, a data processing system for managing an event production comprises an interface means for inputting a plurality of data, a computer processor means for processing said data, a storage means for storing said data on a storage medium, a retrieval means for retrieving said data, a display means for displaying said data, wherein, said system produces a plurality of event production documents for managing said event production.

### BRIEF DESCRIPTION OF THE SEVERAL VIEWS OF DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in this document.

FIG. 1 is a functional block diagram of a suitable computing environment in which the invention may be implemented, in accordance with one embodiment of the invention.

FIG. 2A is a flowchart of a computer software application, in accordance with one embodiment of the invention.

FIG. 2B is a flowchart of a companion software application for tablet computing devices, in accordance with one embodiment of the invention.

FIG. 3 is a representation of a graphical user interface, in Design Mode, in accordance with one embodiment of the invention.

FIG. 4 is a representation of a graphical user interface, in Rehearsal Mode, in accordance with one embodiment of the invention.

FIG. 5 is a representation of a graphical user interface, in Show Mode, in accordance with one embodiment of the invention.

FIG. 6 is a representation of a graphical user interface, in “Offline Mode” on a tablet computing device, in accordance with one embodiment of the invention.

FIG. 7 is a representation of a graphical user interface for a tablet application, in Live Show Mode, in accordance with one embodiment of the invention.

FIG. 8 is a representation of a graphical user interface, countdown clock/speaker timer on a tablet computing device, in accordance with one embodiment of the invention.

FIG. 9A is a flowchart of a plurality of logic processes comprising, adding, removing and editing cues, in accordance with one embodiment of the invention.

FIG. 9B is a flowchart of logic processes associated with a plurality of timers comprising, total run time, cue countdown, duration, countdown timer and stopwatch, in accordance with one embodiment of the invention.

FIG. 9C is a flowchart of functional processes associated with advancing cues and activating timers, in accordance with one embodiment of the invention.

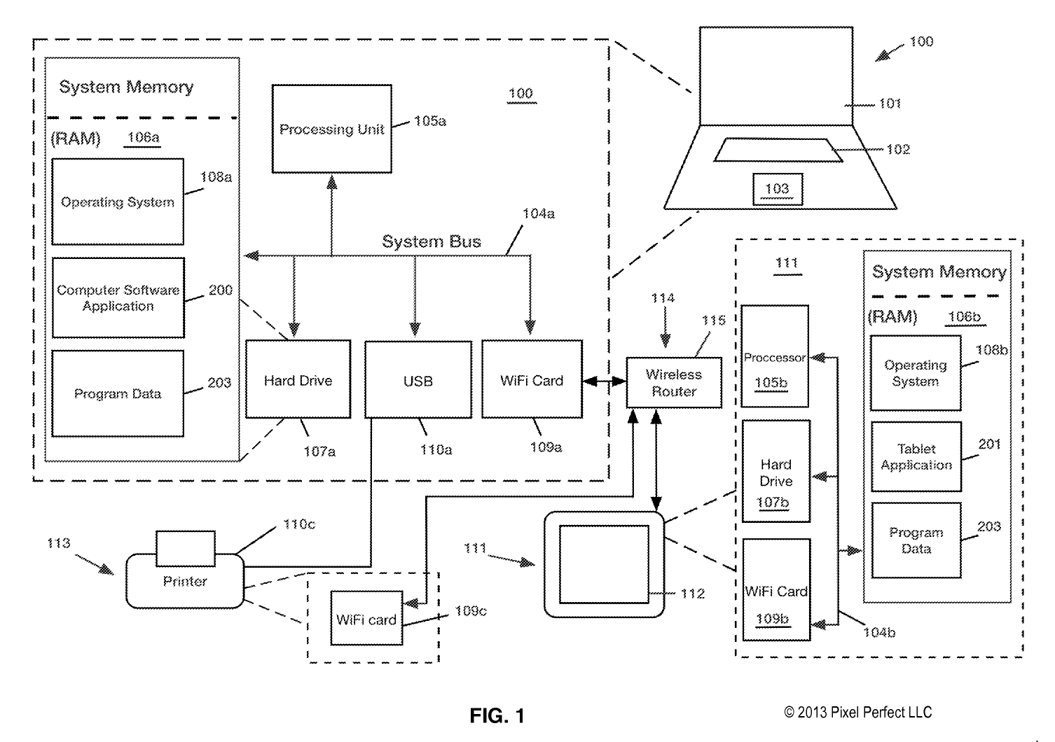

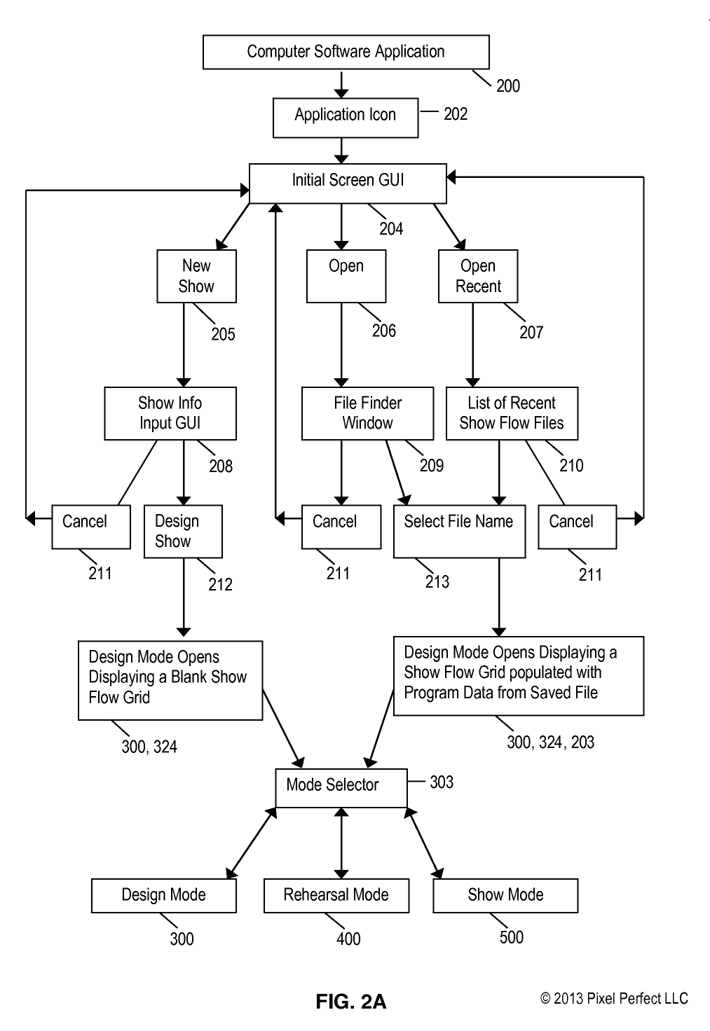

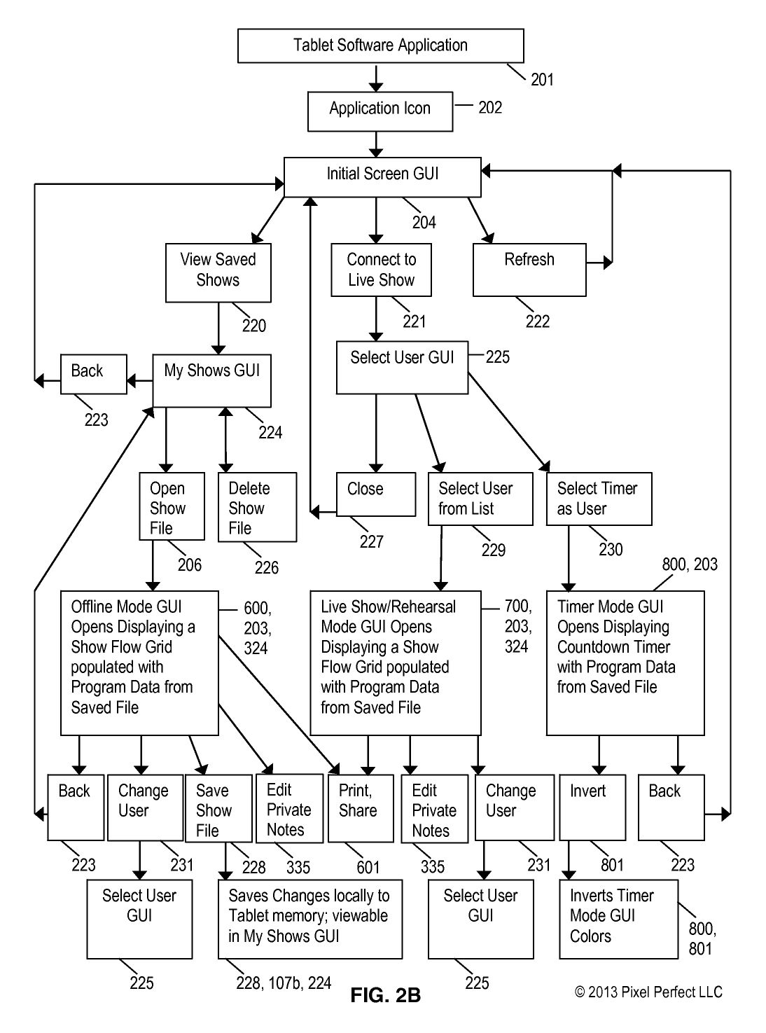

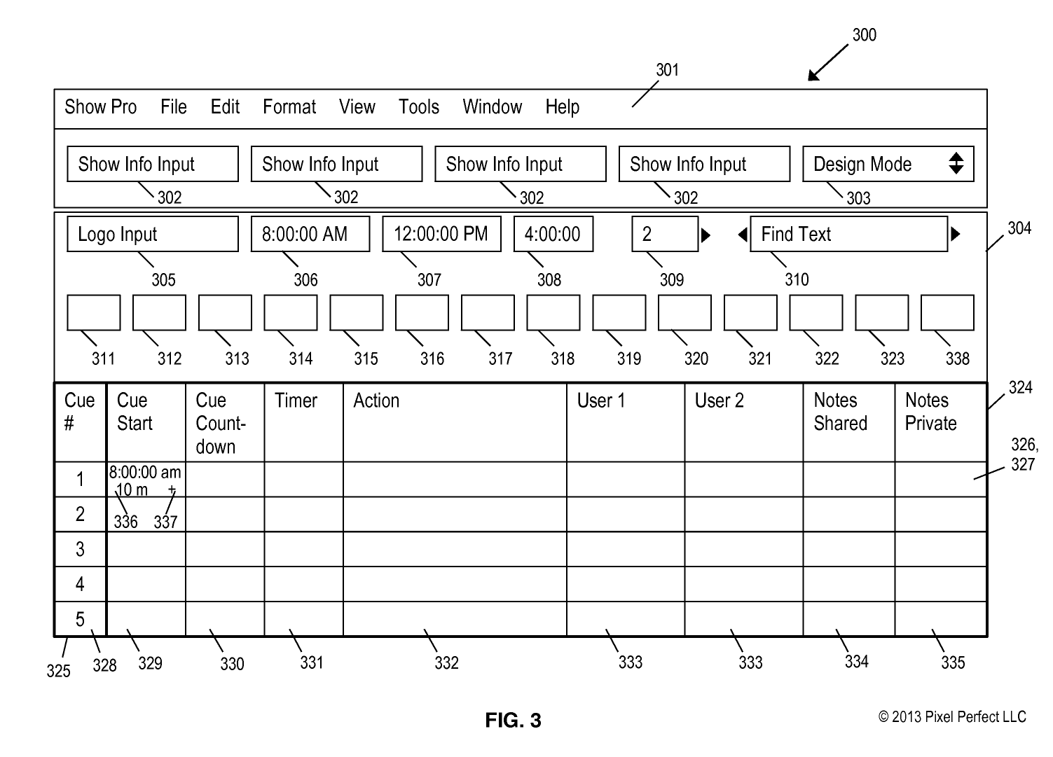

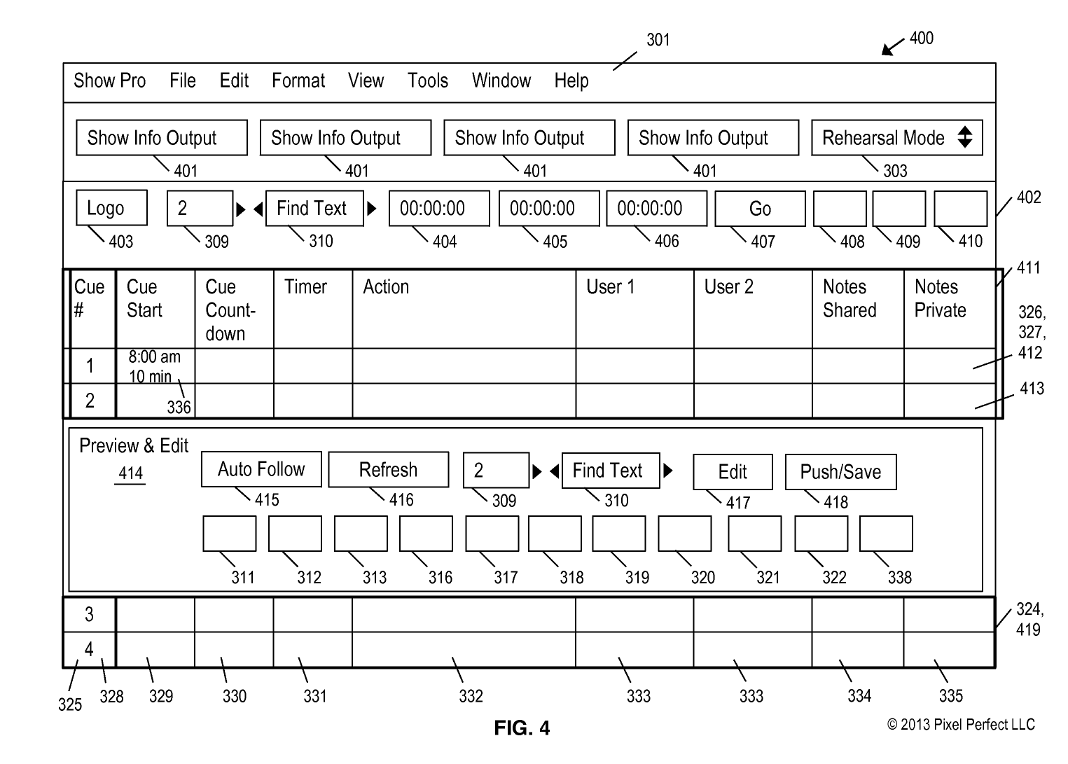

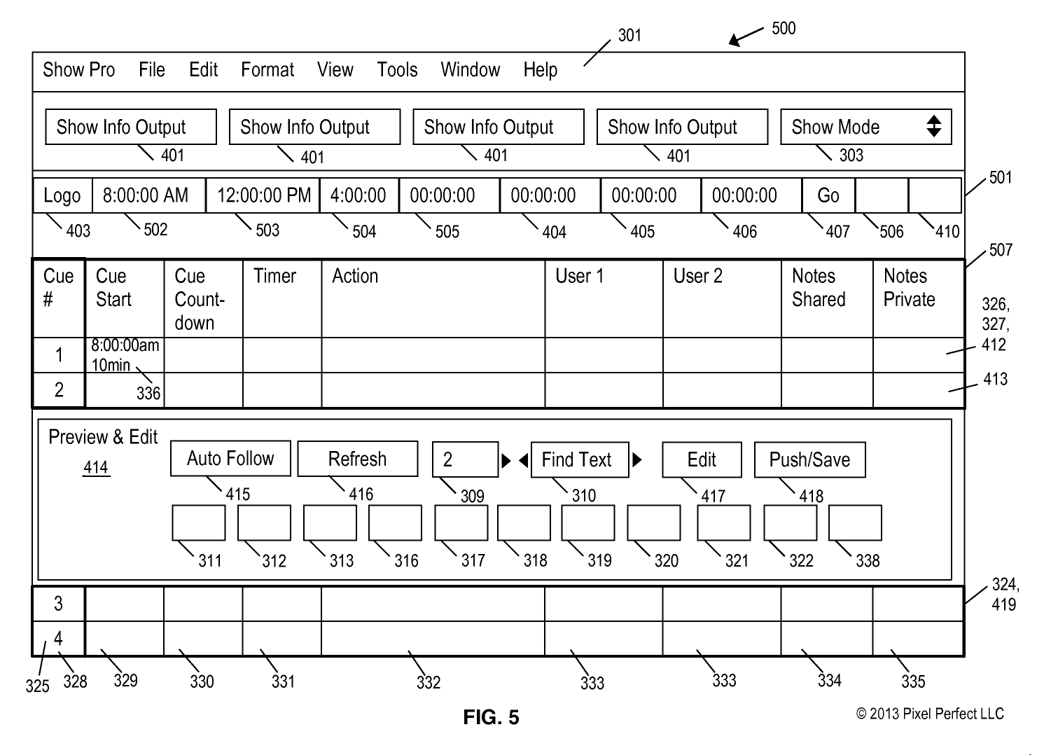

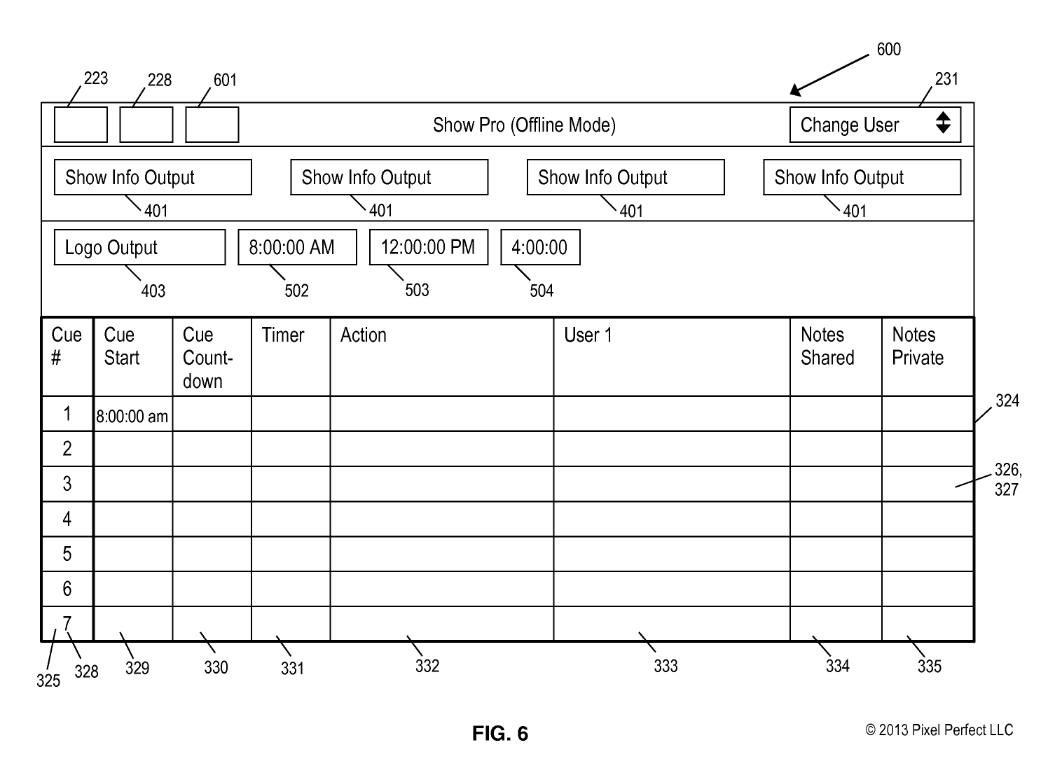

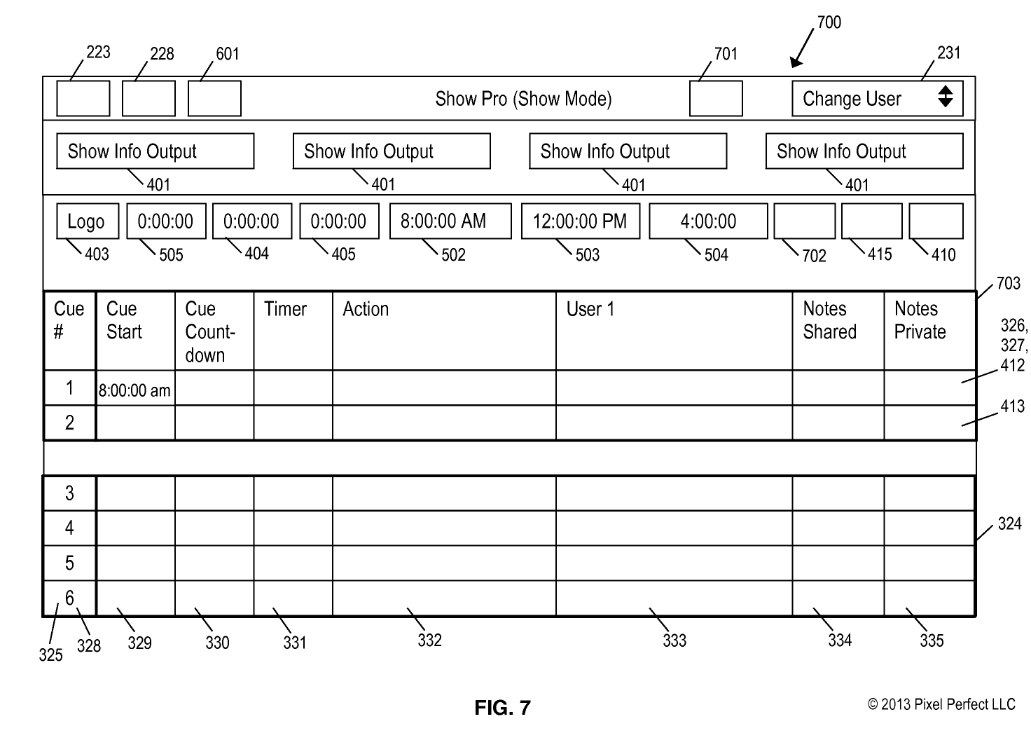

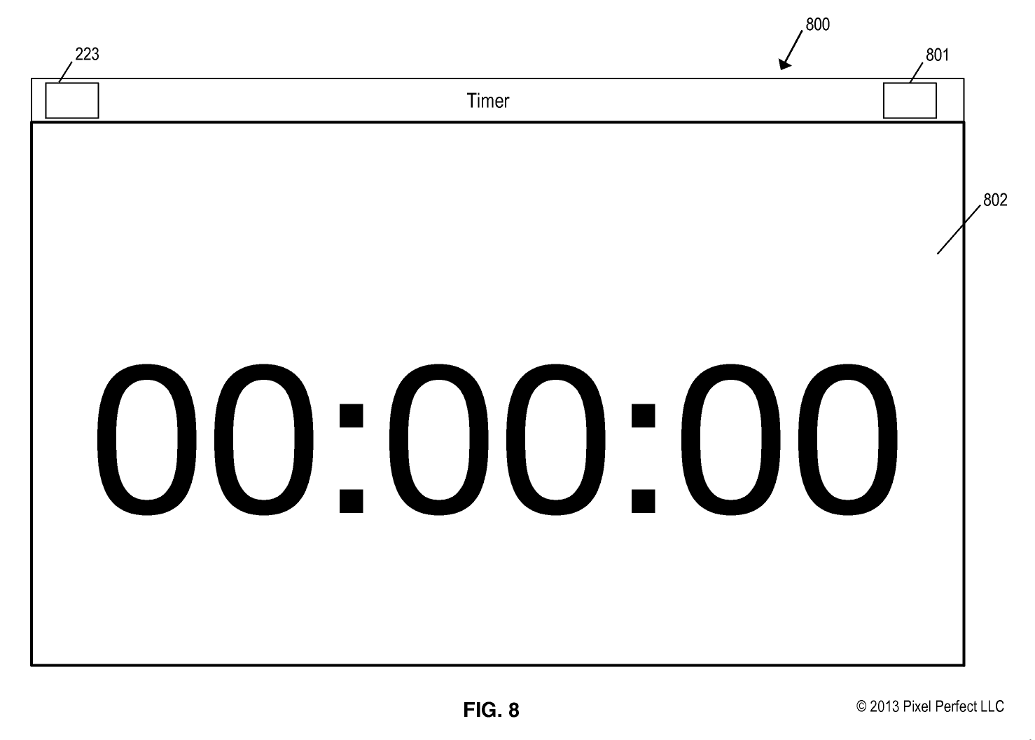

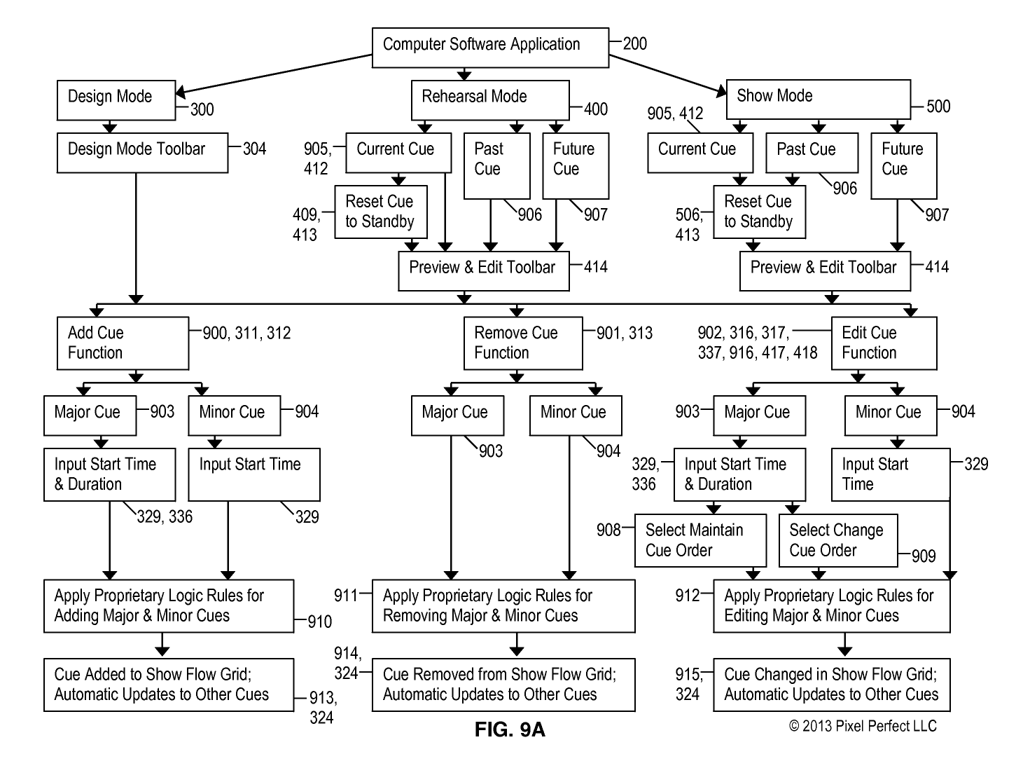

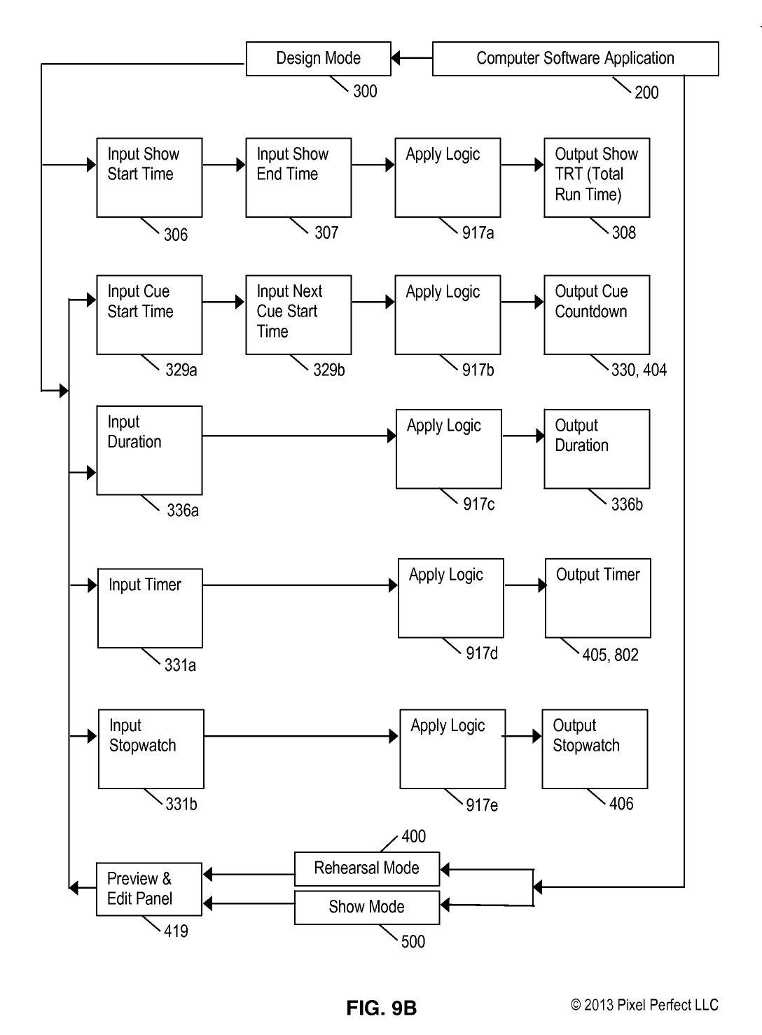

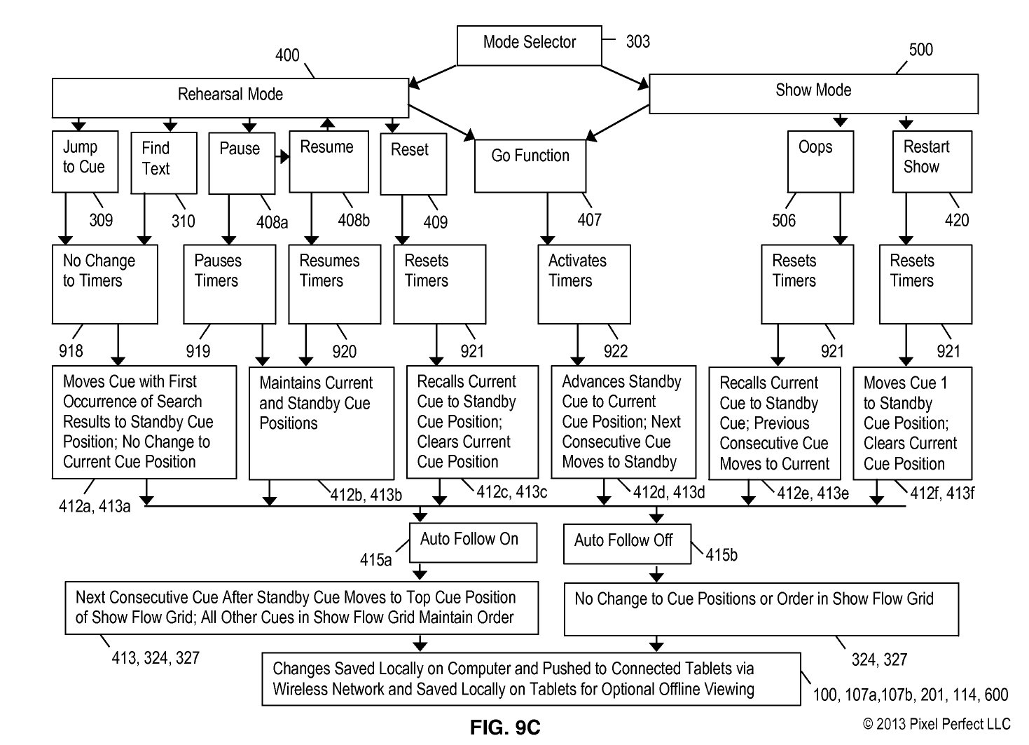

DRAWINGS - REFERENCE NUMERALS

| FIG. # | Ref # | Description |
|---|---|---|
| FIG. 1 | Overall | Functional block diagram of a suitable computing environment in |
| | System | which the invention may be implemented, in accordance with one |
| | | embodiment of the invention. |
| | 100 | Laptop Computer, MacBook Pro Laptop manufactured by Apple |
| | | Inc. |
| | 101 | 15-inch LED-backlit Retina Display, display means |
| | 102 | Built-in Keyboard, input means |
| | 103 | Multi-touch track pad, input means |
| | 104a | System Bus |
| | 105a | 2.4 GHz quad-core Intel Core i7 Processor, data processing |
| | | means |
| | 106a | 8 GB RAM, storage means |
| | 107a | 250 GB Solid State Drive Memory, storage means |
| | 108a | Mountain Lion Operating System (OS X 10.8); computer |
| | | processor means |
| | 109a | 802.11n WiFi card, connection means |
| | 110a | USB 3.0 port, connection means |
| | 111 | Tablet Computing Device, iPad 2 manufactured by Apple Inc. |
| | 104b | System Bus |
| | 105b | Dual-core A5 Processor, processing means |
| | 106b | RAM, storage means |
| | 107b | 16 GB Memory, storage means |
| | 108b | iOS 6.0 Operating System, data processing means |
| | 109b | 802.11a/b/g/n WiFi card, connection means |
| | 112 | 9.7-inch (diagonal) LED-backlit Multi-Touch Display, display |
| | | means |
| | 113 | AirPrint-Enabled Printer, HP Photosmart 6520 e-All-in-One |
| | | Printer |
| | 109c | 802.11 b/g/n WiFi card, connection means |
| | 110c | USB 2.0 Port, connection means |
| | 114 | Wireless Network Router, Airport Extreme Base Station |
| | | manufactured by Apple Inc., connection means |
| | 115 | 802.11a/b/g/n Transmitter, connection means |
| | 200 | Computer Software Application, data processing system for |
| | | managing event production |
| | 201 | Tablet Software Application, companion data processing system |
| | | for managing event production |
| | 203 | Program Data |
| FIG. 2A | Overall | Flowchart of a computer software application, in accordance with |
| | Process | one embodiment of the invention. |
| | 200 | Computer Software Application |
| | 202 | Application Icon |
| | 203 | Program Data |
| | 204 | Initial Screen GUI |
| | 205 | New Show Button |
| | 206 | Open File Function |
| | 207 | Open Recent Button |
| | 208 | Show Info Input GUI |
| | 209 | File Finder Window (native to Operating System) |
| | 210 | List of Recent Show Flow Files (.sho format) |
| | 211 | Cancel Button |
| | 212 | Design Show Button |
| | 213 | Show Flow File |
| | 300 | Design Mode GUI |
| | 303 | Mode Selector |
| | 324 | Show Flow Grid |
| | 400 | Rehearsal Mode GUI |
| | 500 | Show Mode GUI |
| FIG. 2B | Overall | Flowchart of a companion software application for tablet |
| | Process | computing devices, in accordance with one embodiment of the |
| | | invention. |
| | 107b | 16 GB Memory |
| | 201 | Tablet Software Application |
| | 202 | Application Icon |
| | 203 | Program Data |
| | 204 | Initial Screen GUI |
| | 206 | Open File Function |
| | 220 | View Saved Shows Button |
| | 221 | Connect to Live Show Button |
| | 222 | Refresh Button |
| | 223 | Back Button |
| | 224 | My Shows GUI |
| | 225 | Select User GUI |
| | 226 | Delete File Function |
| | 227 | Close Function |
| | 228 | Save File Function |
| | 229 | Select User from List |
| | 230 | Select Timer as User |
| | 231 | Change User Button |
| | 324 | Show Flow Grid |
| | 335 | Private Notes |
| | 600 | Offline Mode GUI |
| | 601 | Print & Share Button |
| | 700 | Live Show/Rehearsal GUI |
| | 800 | Timer Mode GUI |
| | 801 | Invert Button |
| | 802 | Full Screen Timer Countdown Clock |
| FIG. 3 | GUI | Representation of a graphical user interface, in Design Mode, in |
| | | accordance with one embodiment of the invention. |
| | 300 | Design Mode Graphical User Interface |
| | 301 | Drop Down Menu |
| | 302 | Show Info Text Boxes |
| | 303 | Mode Selector |
| | 304 | Design Mode Toolbar |
| | 305 | Logo Input |
| | 306 | Show Start Time Input |
| | 307 | Show End Time Input |
| | 308 | Show TRT (Total Run Time) Output |
| | 309 | Jump to Cue # Shortcut |
| | 310 | Find Text Shortcut |
| | 311 | Quick Cue Shortcut (Insert Quick Cue) |
| | 312 | Cue+ Shortcut (Insert Cue) |
| | 313 | Cue− Shortcut (Remove Cue) |
| | 314 | Column+ Shortcut (Insert Column) |
| | 315 | Column− Shortcut (Remove Column) |
| | 316 | Highlight Selection Shortcut |
| | 317 | Format Font Shortcut |
| | 318 | Undo Shortcut |
| | 319 | Redo Shortcut |
| | 320 | Cut Shortcut |
| | 321 | Copy Shortcut |
| | 322 | Paste Shortcut |
| | 323 | Save Shortcut |
| | 324 | Show Flow Grid |
| | 325 | Columns |
| | 326 | Rows |
| | 327 | Cue |
| | 328 | Cue # Column |
| | 329 | Cue Start Time Column |
| | 330 | Cue Countdown Column |
| | 331 | Timer Column |
| | 332 | Action Column |
| | 333 | User Columns |
| | 334 | Notes Shared Column |
| | 335 | Notes Private Column |
| | 336 | Duration |
| | 337 | More Info + Indicator |
| | 338 | Print Shortcut |
| FIG. 4 | GUI | Representation of a graphical user interface, in Rehearsal Mode, |
| | | in accordance with one embodiment of the invention. |
| | 301 | Drop Down Menu |
| | 303 | Mode Selector |
| | 309 | Jump to Cue # Shortcut |
| | 310 | Find Text Shortcut |
| | 311 | Quick Cue Shortcut (Insert Quick Cue) |
| | 312 | Cue+ Shortcut (Insert Cue) |
| | 313 | Cue− Shortcut (Remove Cue) |
| | 316 | Highlight Selection Shortcut |
| | 317 | Format Font Shortcut |
| | 318 | Undo Shortcut |
| | 319 | Redo Shortcut |
| | 320 | Cut Shortcut |
| | 321 | Copy Shortcut |
| | 322 | Paste Shortcut |
| | 324 | Show Flow Grid |
| | 325 | Columns |
| | 326 | Rows |
| | 327 | Cue |
| | 328 | Cue # Column |
| | 329 | Cue Start Column |
| | 330 | Cue Countdown Column |
| | 331 | Timer Column |
| | 332 | Action Column |
| | 333 | User Columns |
| | 334 | Notes Shared Column |
| | 335 | Notes Private Column |
| | 336 | Duration |
| | 338 | Print Shortcut |
| | 400 | Rehearsal Mode GUI |
| | 401 | Show Info Outputs |
| | 402 | Rehearsal Mode Toolbar |
| | 403 | Logo output |
| | 404 | Cue Countdown output |
| | 405 | Timer output |
| | 406 | Stopwatch |
| | 407 | Go button (Advances cues in any order in Rehearsal Mode) |
| | 408 | Pause/Resume button |
| | 409 | Reset button |
| | 410 | Network Status Indicator |
| | 411 | Rehearsal Mode Panel |
| | 412 | Current Cue Row |
| | 413 | Standby Cue Row |
| | 414 | Preview & Edit Toolbar |
| | 415 | Auto Follow button |
| | 416 | Refresh button |
| | 417 | Edit Button |
| | 418 | Push/Save Button |
| | 419 | Preview & Edit Panel |
| FIG. 5 | GUI | Representation of a graphical user interface, in Show Mode, in |
| | | accordance with one embodiment of the invention. |
| | 301 | Drop Down Menu |
| | 303 | Mode Selector |
| | 309 | Jump to Cue # Shortcut |
| | 310 | Find Text Shortcut |
| | 311 | Quick Cue Shortcut (Insert Quick Cue) |
| | 312 | Cue+ Shortcut (Insert Cue) |
| | 313 | Cue− Shortcut (Remove Cue) |
| | 316 | Highlight Selection Shortcut |
| | 317 | Format Font Shortcut |
| | 318 | Undo Shortcut |
| | 319 | Redo Shortcut |
| | 320 | Cut Shortcut |
| | 321 | Copy Shortcut |
| | 322 | Paste Shortcut |
| | 324 | Show Flow Grid |
| | 325 | Columns |
| | 326 | Rows |
| | 327 | Cue |
| | 328 | Cue # Column |
| | 329 | Cue Start Column |
| | 330 | Cue Countdown Column |
| | 331 | Timer Column |
| | 332 | Action Column |
| | 333 | User Columns |
| | 334 | Notes Shared Column |
| | 335 | Notes Private Column |
| | 336 | Duration |
| | 338 | Print Shortcut |
| | 401 | Show Info Outputs |
| | 403 | Logo Output |
| | 404 | Cue Countdown Output |
| | 405 | Timer Output |
| | 406 | Stopwatch |
| | 407 | Go Button (Advances Cues in Chronological Order in Show |
| | | Mode) |
| | 410 | Network Status Indicator |
| | 412 | Current Cue Row |
| | 413 | Standby Cue Row |
| | 414 | Preview & Edit Toolbar |
| | 415 | Auto Follow button (Toggles on/off) |
| | 416 | Refresh button |
| | 417 | Edit Button |
| | 418 | Push/Save Button |
| | 419 | Preview & Edit Panel |
| | 500 | Show Mode GUI |
| | 501 | Show Mode Toolbar |
| | 502 | Show Start Time Output |
| | 503 | Show End Time Output |
| | 504 | Show TRT Output |
| | 505 | +/−Scheduled Time Output |
| | 506 | Oops Button |
| | 507 | Show Mode Panel |
| FIG. 6 | GUI | Representation of a graphical user interface, in “Offline Mode” on |
| | | a tablet computing device, in accordance with one embodiment of |
| | | the invention. |
| | 223 | Back Button |
| | 228 | Save File Function |
| | 231 | Change User Function |
| | 324 | Show Flow Grid |
| | 325 | Columns |
| | 326 | Rows |
| | 327 | Cue |
| | 328 | Cue # Column |
| | 329 | Cue Start Column |
| | 330 | Cue Countdown Column |
| | 331 | Timer Column |
| | 332 | Action Column |
| | 333 | User Columns |
| | 334 | Notes Shared |
| | 335 | Notes Private |
| | 401 | Show Info Outputs |
| | 403 | Logo output |
| | 502 | Show Start Time Output |
| | 503 | Show End Time Output |
| | 504 | Show TRT Output |
| | 600 | Offline Mode GUI |
| | 601 | Print & Share Button |
| FIG. 7 | GUI | Representation of a graphical user interface for a tablet |
| | | application, in Live Show Mode, in accordance with one |
| | | embodiment of the invention. |
| | 223 | Back Button |
| | 228 | Save File Function |
| | 231 | Change User Function |
| | 324 | Show Flow Grid |
| | 325 | Columns |
| | 326 | Rows |
| | 327 | Cue |
| | 328 | Cue # Column |
| | 329 | Cue Start Column |
| | 330 | Cue Countdown Column |
| | 331 | Timer Column |
| | 332 | Action Column |
| | 333 | User Columns |
| | 334 | Notes Shared Column |
| | 335 | Notes Private Column |
| | 401 | Show Info Outputs |
| | 403 | Logo Output |
| | 404 | Cue Countdown |
| | 405 | Timer Countdown |
| | 410 | Network Status Indicator |
| | 412 | Current Cue Row |
| | 413 | Standby Cue Row |
| | 415 | Auto Follow Button (Toggles on/off) |
| | 502 | Show Start Time Output |
| | 503 | Show End Time Output |
| | 504 | Show TRT Output |
| | 505 | +/−Scheduled Clock |
| | 601 | Print & Share Button |
| | 700 | Live Rehearsal/Live Show Mode GUI |
| | 701 | Updated Cues Notification |
| | 702 | My Next Cue Indicator |
| | 703 | Current & Standby Panel |
| FIG. 8 | GUI | Representation of a graphical user interface, countdown |
| | | clock/speaker timer on a tablet computing device, in accordance |
| | | with one embodiment of the invention. |
| | 223 | Back Button |
| | 800 | Timer Mode GUI |
| | 801 | Invert |
| | 802 | Full Screen Timer Countdown Clock |
| FIG. 9A | Detail | Flowchart of a plurality of logic processes comprising, adding, |
| | Process | removing and editing cues, in accordance with one embodiment |
| | | of the invention. |
| | 200 | Computer Software Application |
| | 300 | Design Mode GUI |
| | 304 | Design Mode Toolbar |
| | 311 | Quick Cue Shortcut (Insert Quick Cue) |
| | 312 | Cue+ Shortcut (Insert Cue) |
| | 313 | Cue− Shortcut (Remove Cue) |
| | 316 | Highlight Selection Shortcut |
| | 317 | Format Font Shortcut |
| | 324 | Show Flow Grid |
| | 327 | Cue |
| | 329 | Cue Start Column |
| | 336 | Duration |
| | 400 | Rehearsal Mode GUI |
| | 409 | Reset Button |
| | 412 | Current Cue Row |
| | 413 | Standby Cue Row |
| | 414 | Preview & Edit Toolbar |
| | 417 | Edit Button |
| | 418 | Push/Save Button |
| | 500 | Show Mode GUI |
| | 506 | Oops Button, Reset Current Cue to Standby Cue |
| | 900 | Add Cue Function |
| | 901 | Remove Cue Function |
| | 902 | Edit Cue Function |
| | 903 | Major Cue |
| | 904 | Minor Cue, Associated Minor Cues & Unassociated Minor Cues |
| | 905 | Current Cue |
| | 906 | Past Cue |
| | 907 | Future Cue |
| | 908 | Maintain Cue Order |
| | 909 | Change Cue Order |
| | 910 | Logic for Adding Cues |
| | 911 | Logic for Removing Cues |
| | 912 | Logic for Editing Cues |
| | 913 | Cue Added to Show Flow Grid; Automatic Updates to Other Cues |
| | 914 | Cue Removed from Show Flow Grid; Automatic Updates to Other |
| | | Cues |
| | 915 | Cue Editing in Show Flow Grid; Automatic Updates to Other Cues |
| | 916 | Edit Column Label |
| FIG. 9B | Detail | Flowchart of logic processes associated with a plurality of timers |
| | Process | comprising, total run time, cue countdown, duration, countdown |
| | | timer and stopwatch, in accordance with one embodiment of the |
| | | invention. |
| | 200 | Computer Software Application |
| | 300 | Design Mode GUI |
| | 306 | Show Start Time Input |
| | 307 | Show End Time Input |
| | 308 | Show TRT (Total Run Time) Output |
| | 329 | Cue Start Column |
| | 330 | Cue Countdown Column |
| | 331 | Timer Column |
| | 336 | Duration |
| | 400 | Rehearsal Mode GUI |
| | 404 | Cue Countdown output |
| | 405 | Timer output |
| | 406 | Stopwatch |
| | 419 | Preview & Edit Panel |
| | 500 | Show Mode GUI |
| | 802 | Full Screen Timer Countdown Clock |
| | 917 | Logic for Timers |
| FIG. 9C | Detail | Flowchart of functional processes associated with advancing |
| | Process | cues and activating timers, in accordance with one embodiment |
| | | of the invention. |
| | 100 | Laptop Computer, MacBook Pro Laptop manufactured by Apple |
| | | Inc. |
| | 107a | 250 GB Solid State Drive Memory |
| | 107b | 16 GB Memory |
| | 111 | Tablet Computing Device, iPad 2 manufactured by Apple Inc. |
| | 114 | Wireless Network Router, Airport Extreme Base Station |
| | | manufactured by Apple Inc. |
| | 201 | Tablet Software Application |
| | 303 | Mode Selector |
| | 309 | Jump to Cue # Shortcut |
| | 310 | Find Text Shortcut |
| | 324 | Show Flow Grid |
| | 327 | Cue |
| | 400 | Rehearsal Mode GUI |
| | 407 | Go button |
| | 408a | Pause Button |
| | 408b | Resume Button |
| | 409 | Reset button |
| | 412 | Current Cue Row |
| | 413 | Standby Cue Row |
| | 415 | Auto Follow button |
| | 420 | Restart Show |
| | 500 | Show Mode GUI |
| | 506 | Oops Button |
| | 600 | Offline Mode GUI |
| | 918 | No Change to Timers |
| | 919 | Pauses Timers |
| | 920 | Resumes Timers |
| | 921 | Resets Timers |
| | 922 | Activates Timers |

### DETAILED DESCRIPTION OF THE FIRST EMBODIMENT

All descriptions are for the purpose of illustrating selected embodiments of the present invention and are not intended to limit the scope of the present invention.

FIG. 1 shows a functional block diagram illustrating an example computing system for implementing the invention, including a representation of a conventional laptop computer 100, also referred to as a laptop or a computer, in the form of a MacBook Pro laptop manufactured by Apple Inc., in accordance with one embodiment. The laptop computer 100 has a 15-inch LED-backlit Retina Display 101, a built-in keyboard 102, a multi-touch track pad 103. The laptop computer 100 has a system bus 104a that couples with various system components including a 2.4 GHz quad-core Intel Core i7 processor 105a, an 8 GB RAM 106a and a 250 GB solid state drive memory 107a. The laptop computer 100 utilizes a Mountain Lion operating system (OS X 10.8) 108a. The laptop computer 100 has a built-in 802.11n WiFi card 109a and multiple ports including a plurality of USB 3.0 ports 110a for connecting with a plurality of devices. The laptop computer 100 operates a computer software application 200 (FIG. 2A) and processes a plurality of program data 203, in accordance with one embodiment.

FIG. 1 also shows a representation of a tablet computing device 111 for implementing the invention, also referred to as a tablet computer or a tablet, in the form of an iPad 2 manufactured by Apple Inc., in accordance with one embodiment. The tablet 111 has a 9.7-inch (diagonal) LED-backlit multi-touch display 112. The tablet 111 has a system bus 104b that couples with various system components including a Dual-core A5 processor 105b, a RAM 106b, and a 16 GB Memory 107b. The tablet 111 utilizes an iOS 6.0 operating system 108b. The tablet 111 and has an 802.11a/b/g/n WiFi card 109b for connecting with a plurality of devices. The tablet computer 111 operates a tablet software application 201 and processes the plurality of program data 203, in accordance with one embodiment.

FIG. 1 further shows a representation of an AirPrint-enabled printer 113, also referred to as a printer, in the form of an HP Photosmart 6520 e-All-in-One Printer manufactured by Hewlett-Packard, in accordance with one embodiment. The printer 113 has an 802.11b/g/n Wi-Fi card 109c and a USB 2.0 port 110c to connect with a plurality of devices.

FIG. 1 additionally shows a representation of a wireless network router 114, also referred to as a wireless router, in the form of an Airport Extreme Base Station manufactured by Apple Inc., in accordance with one embodiment. The wireless network router 114 has an 802.11a/b/g/n transmitter 115 which connects with a plurality of devices such as the MacBook Pro laptop computer 100, the iPad 2 tablet 111 or the printer 113, for example.

FIG. 2A shows a flowchart of the basic process of operating the software application 200, in accordance with one embodiment of the invention. By means of the computer 100 (FIG. 1), the user launches the software application 200 in the customary fashion, for example by clicking on an application icon 202 on the desktop or selecting a file name 213 from a conventional file menu 209.

Once the software application 200 is opened, an initial screen graphical user interface (GUI) 204 is displayed on the computer display screen 101 (FIG. 1). From the initial screen GUI 204, the user can select from one of three options, a “new show” button 205, an “open” button 206 or an “open recent” button 207.

Selecting the “new show” function 205 opens a “show info” input GUI 208 whereby the user can input descriptive text such as a venue name, show date, client name, for example. Then the user can either select a “cancel” button 211 or a “design show” button 212. Selecting the “cancel” button 211 takes user back to the initial screen GUI 204. Selecting the “design show” button 212 opens the software application 200 in a first module for designing, formatting and modifying the show flow as illustrated by a “Design Mode” GUI 300 (FIG. 3).

Or instead, the user may select the “open” button 206 from the initial screen GUI 204, which opens a conventional file finder window 209 where the user may select a file name 213 to open the file in the software application 200. Once the file is opened, the user may continue to design, format and modify the show flow in the “Design Mode” GUI 300 (FIG. 3) by making changes to a show flow grid 324 (FIG. 3). The show flow grid 324 (FIG. 3 is the graphical representation of the show flow in the computer software application 200.

Alternatively, the user may select the “open recent” button 207 from the initial screen GUI 204, which displays a list of files which have been recently opened 210 by the software application 200. The user may select the file name 213 to open the file in the software application 200. The opened file is displayed in the “Design Mode” GUI 300 (FIG. 3).

In order to rehearse the cues of the show flow, the user may select a second module of the software application 200 in a “Rehearsal Mode” GUI 400. A third module of the software application 200 opens the file in a “Show Mode” GUI 500 in which the user is able to view the show flow and manage the communication to the production team during the live event.

In order to alternate between modes, the user may click on a “mode selector” 303 (FIG. 3) which includes the plurality of modes comprising, the “Design Mode” 300 (FIG. 3), the “Rehearsal Mode” 400 (FIG. 4) and the “Show Mode” 500 (FIG. 5).

FIG. 2B shows a flowchart of the basic process of operating the tablet software application 201, in accordance with one embodiment of the invention. By means of the tablet 111 (FIG. 1), the user launches the tablet application 201 in the customary fashion, for example by clicking on the application icon 202 on the touch display 112 (FIG. 1).

Once the tablet application 201 is opened, the initial screen graphical user interface 204 is displayed on the touch display 112 (FIG. 1). From the initial screen GUI 204, the user can select from a plurality of options including, a “view saved shows” button 220, a “connect to live show” button 221 or a “refresh” button 222.

Selecting the “view saved shows” button 220 displays a “My Shows” GUI 224 whereby the user may select from the list of saved show flow files 210 (FIG. 2A). From the “My Shows” GUI 224, the user can select from a plurality of options including, the function to open 206 the show flow file 213 (FIG. 2A), the function to delete 226 the show flow file 213 (FIG. 2A), or a “back” button 223 to return to the initial screen GUI 204. Selecting the delete 226 show flow function removes the show flow file 213 (FIG. 2A) and the corresponding program data 203 from the memory 107 (FIG. 1) of the tablet 111 (FIG. 1). Selecting the open show flow file function 206 displays an “offline mode” GUI 600.

Alternatively, from the initial screen GUI 204, the user may select the “connect to live show” button 221 which displays a “select user” GUI 225. Then the user may select from a list of users 229, select a “timer as user” option 230 or select a close function 227. Selecting from the list of users 229 opens the show flow file 213 (FIG. 2A) in a “live show/rehearsal” GUI 700.

Selecting the “timer as user” function 230 opens a “Timer Mode” GUI 800 (FIG. 8) and displays a full screen sized countdown timer 802 (FIG. 8) using the corresponding program data 203. Once the “Timer Mode” GUI 800 is open, the user has the option of selecting the “back” button 223 or an “invert” button 801 (FIG. 8). The “back” button 223 returns the user to the initial screen GUI 204. The “invert” button 801 (FIG. 8) inverts the colors of the “Timer Mode” GUI 800 (FIG. 8).

Within the “offline mode” GUI 600 (FIG. 6) or the “live show/rehearsal” GUI 700 (FIG. 7), the user may select the back button 223, select a change users function 231, edit a private notes field 335 (FIG. 6), select a save function 228, or select a print or share function 601 the show flow file 213 (FIG. 2A). Selecting the back button 223 returns the user to the “My Shows” GUI 224. Selecting the change users function 231 displays a “select user” GUI 225 displaying the list of users corresponding to the show flow file 213 (FIG. 2A). Making a selection from the list of users 229 then populates the show flow grid 324 (FIG. 3) with the corresponding program data 203 from the show flow file 213 (FIG. 2A). The private notes 335 (FIG. 6) are saved locally on the memory 107b (FIG. 1) and are viewable in the corresponding show flow file 213 (FIG. 2A). whether the user is in offline mode 600 (FIG. 6) or live show/rehearsal mode 700 (FIG. 7).

FIG. 3 shows the first implementation of the software application 200 (FIG. 2A) as the “Design Mode” graphical user interface (GUI) 300, to be utilized by means of the computer 100 (FIG. 1), in accordance with one embodiment. The “Design Mode” GUI 300 is the module within which the user may design the show flow 213 (FIG. 2A) using fields such as: a “cue start time” column 329, a “duration” field 336, a plurality of “action” or descriptive element columns 332, a plurality of “user” columns 333, a “shared notes” column 334, and a “private notes” column 335, and may customize the show flow 213 (FIG. 2A) to meet user needs and preferences.

The “Design Mode” GUI 300, has an upper toolbar with a plurality of drop down menus 301 with labels comprising of “File”, “Edit”, “Format”, “View”, “Tools”, “Window” and “Help”, for example. The user opens the drop down menu 301 by common techniques, such as by using the mouse or the track pad 103 (FIG. 1) or by using keyboard shortcuts.

Below the dropdown menu 301 is a plurality of “Show Info” text boxes 302 to input information about the event production such as venue, client name, show date, show flow version number or show title, for example. To the right of the “Show Info” text boxes 302 is a mode selector 303 to alternate between the “Design Mode” 300 (FIG. 3), the “Rehearsal Mode” 400 (FIG. 4) and the “Show Mode” 500 (FIG. 5).

Below the “Show Info” text boxes 302 and the mode selector 303 is a “Design Mode” toolbar 304 with a plurality of user inputs, outputs and shortcuts comprising: a logo input 305, a “show start” time input 306, a “show end” time input 307, a “Show TRT” (total run time) output 308, a “jump to cue #” shortcut 309, a “find text” shortcut 310, a “Quick Cue” shortcut 311, a “Cue+” shortcut 312, a “Cue=” shortcut 313, a “Column+” shortcut 314, a “Column−” shortcut 315, a “highlight selection” shortcut 316, a “format font” shortcut 317, an “undo” shortcut 318, a “redo” shortcut 319, a “cut” shortcut 320, a “copy” shortcut 321, a “paste” shortcut 322, and a “save” shortcut 323.

Below the “Design Mode” toolbar 304 is the “show flow grid” 324 comprising of a plurality of columns 325 and a plurality of rows 326. The default columns 325 comprising of a “Cue#” column 328, the “Cue Start” column 329, a “Cue Countdown” column 330, the “Timer” column 331, the “Action” column 332, the plurality of “User” columns 333, the “Notes Shared” column 334 and the “Notes Private” column 335. The “show flow grid” 324 is also comprised of a plurality of the rows 326 identified by numerals 1, 2, 3 etc. Each row 326 represents a cue 327 in the “show flow grid” 324. By default, the rows 326 are blank until the user adds cues 327 to the “show flow grid” 324.

In “Design Mode” 300, additional action columns 332 and user columns 333 may be added to the “show flow grid” 324 by clicking on the “Column+” shortcut 314 in the “Design Mode” toolbar 304 or by utilizing the corresponding command in the dropdown menu 301, for example. User columns 333 may be removed by clicking on the “Column-” shortcut 315 in the “Design Mode” toolbar 304 or via the dropdown menu 301, for example. The action columns 332 or user columns 333 may be customized by right clicking the column header. Dragging and dropping the columns 325 into their desired order by means of the mouse or the track pad 103 changes the ordering of the columns 325.

If there is more text in a cell than is visible on the screen, a “more info+indicator” 337 is displayed. When the user clicks on the “more info+indicator” 337, an expanded text pop over screen opens up with the complete alphanumeric text in a proportionately larger scrolling window. The “more info+indicator” is also functional in the other modes and in the tablet application 201 (FIG. 2B).

FIG. 4 shows the second implementation of the software application 200 (FIG. 2A) as the “Rehearsal Mode” graphical user interface (GUI) 400, to be utilized by means of the computer 100 (FIG. 1), in accordance with one embodiment. The “Rehearsal Mode” GUI 400 is a module within which the user can rehearse the show flow 213 (FIG. 2A) and share the show flow file 213 (FIG. 2A) with a plurality of production team members, for example using the tablets 111 (FIG. 1), operating the tablet software application 201 (FIG. 2B).

The “Rehearsal Mode” GUI 400 includes the upper toolbar with the plurality of drop down menus 301 comprising of “File”, “Edit”, “Format”, “View”, “Tools”, “Window” and “Help”, for example. The user may select the drop down menu 301 by common techniques, such as by clicking with the mouse or the track pad 103 (FIG. 1) or by using keyboard shortcuts.

Below the dropdown menu 301 is a plurality of “Show Info” outputs 401 which are read only in the “Rehearsal Mode” 400. To the right of the “Show Info” outputs 401 is the mode selector 303 to alternate between the “Design Mode” 300 (FIG. 3), the “Rehearsal Mode” 400 and the “Show Mode” 500 (FIG. 5).

Below the “Show Info” outputs 401 and the mode selector 303 is a “Rehearsal Mode” toolbar 402 with a plurality user inputs, outputs and shortcuts including: a “logo” output 403, the “jump to cue #” shortcut 309, the “find text” shortcut 310, a “Cue Countdown” output 404, a “Timer” output 405, a “Stopwatch” 406, a “Go” button 407, a “Pause” button 408, a “Reset” button 409 and a “Network Status” indicator 410.

Below the “Rehearsal Mode” toolbar 402 is a “Rehearsal Mode” panel 411 comprising a plurality of the columns 325 and rows 326. The columns 325 comprising: the “Cue#” column 328, the “Cue Start” column 329, the “Cue Countdown” column 330, the “Timer” column 331, the plurality of “Action” columns 332, the plurality of “User” columns 333, the “Notes Shared” column 334 and the “Notes Private” column 335. The “Rehearsal Mode” panel 411 is comprised of a plurality of rows 326, including a “Current Cue” row 412 and a “Standby Cue” row 413. By default, the “Current Cue” row 412 is blank until the “Go” function 407 advances the cues 327.

Below the “Rehearsal Mode” panel 411 is a “Preview & Edit” toolbar 414 with a plurality of user inputs, outputs and shortcuts comprising of: an “Auto Follow” button 415, a “Refresh” button 416, the “Jump to Cue” shortcut 309, the “Find Text” shortcut 310, an “Edit” button 417, a “Push/Save” button 418, the “Quick Cue” shortcut 311, the “Cue+” shortcut 312, the “Cue−” shortcut” 313, the “highlight selection” shortcut 316, the “format font” shortcut 317, the “undo” shortcut 318, the “redo” shortcut 319, the “cut” shortcut 320, the “copy” shortcut 321 and the “paste” shortcut 322.

Below the “Preview & Edit” toolbar 414 is a “Preview & Edit” panel 419 containing the “show flow grid” 324, comprising of a plurality of columns 325 and rows 326. The columns 325 comprising: the “Cue#” column 328, the “Cue Start” column 329, the “Cue Countdown” column 330, the “Timer” column 331, the plurality of “Action” columns 332, the plurality of “User” columns 333, the “Notes Shared” column 334 and the “Notes Private” column 335. The “show flow grid” 324 is also comprised of a plurality of rows 326 identified by numerals 1, 2, 3 etc. Each row 326 represents a cue 327 in the “show flow grid” 324. By default, the rows 326 are blank until cues 327 are added to the “show flow grid” 324.

In the “Preview & Edit Panel” 419, the user may add additional cues 327 to the “show flow grid” 324 by, clicking on the “Edit” button 417 and then by clicking on the “Cue+” shortcut 312, the “Quick Cue” shortcut 311 or by selecting the corresponding options in the dropdown menu 301 and then clicking the “push/save” button 418, for example.

FIG. 5 shows the third implementation of the software application 200 (FIG. 2A) as the “Show Mode” graphical user interface (GUI) 500, to be utilized by means of the computer 100 (FIG. 1), in accordance with one embodiment. The “Show Mode” GUI 500 is the module within which the user is able to manage the live event production and communicate with the plurality production team members using tablets 111 (FIG. 1), operating the tablet software application 201 (FIG. 2B).

The “Show Mode” GUI 500 includes the upper toolbar with the plurality of drop down menus 301 comprising of “File”, “Edit”, “Format”, “View”, “Tools”, “Window” and “Help”, for example. The user may select the drop down menu 301 by common techniques, such as by clicking with the mouse or the track pad 103 (FIG. 1) or by using keyboard shortcuts.

Below the dropdown menu 301 is the plurality of “Show Info” outputs 401 which are read only in the “Show Mode” 500. To the right of the “Show Info” outputs 401 is the mode selector 303 to alternate between the “Design Mode” 300 (FIG. 3), the “Rehearsal Mode” 400 (FIG. 4) and the “Show Mode” 500.

Below the “Show Info” outputs 401 and the mode selector 303 is a “Show Mode” toolbar 501 with a plurality of user inputs, outputs and shortcuts including: the “logo” output 403, a “Show Start Time” output 502, a “Show End Time” output 503, a “Show TRT” (total run time) output 504, a “+/−Time” output 505, the “Cue Countdown” output 404, the “Timer” output 405, the “Stopwatch” 406, the “Go” button 407, an “Oops” button 506 and the “Network Status” indicator 410.

Below the “Show Mode” toolbar 501 is a “Show Mode” panel 507 comprising the plurality of columns 325 and rows 326. The columns 325 comprising: the “Cue#” column 328, the “Cue Start” column 329, the “Cue Countdown” column 330, the “Timer” column 331, the plurality of “Action” columns 332, the plurality of “User” columns 333, the “Notes Shared” column 334 and the “Notes Private” column 335. The “Show Mode” panel 507 is comprised of a plurality of rows 326, including the “Current Cue” row 412 and the “Standby Cue” row 413. By default, the “Current Cue” row 412 is blank until the “Go” function 407 advances the cues 327.

Below the “Show Mode” panel 507 is the “Preview & Edit” toolbar 414 with the plurality of user inputs, outputs and shortcuts comprising: the “Auto Follow” button 415, the “Refresh” button 416, the “Jump to Cue” shortcut 309, the “Find Text” shortcut 310, the “Edit” button 417, the “Push/Save” button 418, the “Quick Cue” shortcut 311, the “Cue+” shortcut 312, the “Cue−” shortcut” 313, the “highlight selection” shortcut 316, the “format font” shortcut 317, the “undo” shortcut 318, the “redo” shortcut 319, the “cut” shortcut 320, the “copy” shortcut 321 and the “paste” shortcut 322.

Below the “Preview & Edit” toolbar 414 is the “Preview & Edit” panel 419 containing the “show flow grid” 324, comprising of the plurality of columns 325 and rows 326. The columns 325 comprising: the “Cue#” column 328, the “Cue Start” column 329, the “Cue Countdown” column 330, the “Timer” column 331, the plurality of “Action” columns 332, the plurality of “User” columns 333, the “Notes Shared” column 334 and the “Notes Private” column 335. The “show flow grid” 324 is also comprised of the plurality of rows 326 identified by numerals 1, 2, 3 etc. Each row 326 represents one cue 327 in the “show flow grid” 324. By default, the rows 326 are blank until cues 327 are added to the “show flow grid” 324.

In the “Preview & Edit Panel” 419, the user may add additional cues 327 to the “show flow grid” 324 by clicking the “Edit” button 417 and then by clicking on the “Cue+” shortcut 312, the “Quick Cue” shortcut 311 or by selecting the corresponding options in the dropdown menu 301 and then clicking the “push/save” button 418, for example.

FIG. 6 illustrates the first implementation of the tablet software application 201 (FIG. 2B) as the graphical user interface (GUI) in “Offline Mode” 600, to be utilized by means of the tablet 111 (FIG. 1), in accordance with one embodiment.

The “Offline Mode” GUI 600 is the module within which the user is able to view the show flow 213 (FIG. 2A) while not connected to the computer 100 (FIG. 1) operating the computer software application 200 (FIG. 2A) via the wireless network router 114 (FIG. 1). It may be useful for the user to view the show flow file 213 (FIG. 2A) for example, while traveling on an airplane, before or after the live event to prepare for the show or to make private notes, or during the live event in an instance where the tablet 111 (FIG. 1) disconnects from the wireless network 114 (FIG. 1) and needs a backup version of the show flow 213 (FIG. 2A) to continue properly executing the live event production.

The “Offline Mode” GUI 600 includes an upper toolbar with the plurality of shortcuts comprising of the “Back” button 223, the “Save” button 228, a “Print & Share” button 601, and a “Change User” function 231.

Below the toolbar is the plurality of “Show Info” outputs 401 which are read-only in the tablet application 201 (FIG. 2B) and may include information regarding the live event such as venue, client name, show date, version number or show title, for example.

Below the “Show Info” outputs 401 there are various read-only outputs including: the logo output 403, the “show start time” output 502, the “show end time” output 503 and the “show TRT” (total run time) output 504.

Below the read-only outputs is the “show flow grid” 324 comprising of the plurality of columns 325 and rows 326. The columns 325 comprising: the “Cue#” column 328, the “Cue Start” column 329, the “Cue Countdown” column 330, the “Timer” column 331, the plurality of “Action” columns 332, the plurality of “User” columns 333, the “Notes Shared” column 334 and the “Notes Private” column 335 and are read-only in the tablet application 201 (FIG. 2B). The “show flow grid” 324 is comprised of the plurality of rows 326 identified by numerals 1, 2, 3 etc. Each row 326 represents one cue 327 in the “show flow grid” 324. Changes to the columns 325 and cues 327 may be made by utilizing the computer software application 200 (FIG. 2A) by means of the computer 100 (FIG. 1). The user of the tablet application 201 (FIG. 2B) may, however edit the private notes 335.

FIG. 7 illustrates the second implementation of the tablet software application 201 (FIG. 2B) as the graphical user interface (GUI) in “Live Show/Rehearsal Mode” 700, to be utilized by means of the tablet 111 (FIG. 1), in accordance with one embodiment.

The “Live Show/Rehearsal Mode” GUI 700 is the module within which the user is able to view the show flow 213 (FIG. 2A) while connected to the computer 100 (FIG. 1) operating the computer software application 200 (FIG. 2A) via the wireless network router 114 (FIG. 1). As the Stage Manager makes changes to the show flow 213 (FIG. 2A), the changes are displayed in real-time on the tablet 111 (FIG. 1), in “Live Show/Rehearsal Mode” 700.

The “Live Show/Rehearsal Mode” GUI 700 includes the upper toolbar with the plurality of shortcuts and indicators comprising of the “Back” button 223, the “Save” button 228, the “Print & Share” button 601, an “Updated Cues Notification” 701 and the “Change User” function 231.

Below the toolbar is the plurality of “Show Info” outputs 401 which are read-only in the tablet application 201 (FIG. 2B) and may include information regarding the live event such as venue, client name, show date, version number or show title, for example.

Below the “Show Info” outputs 401 there are various outputs, indicators and buttons including: the logo output 403, the “+/−Scheduled Time” output 505, the “Cue Countdown” output 404, the “Timer Countdown” output 405, the “show start time” output 502, the “show end time” output 503, the “show TRT” (total run time) output 504, a “My Next Cue” indicator 702, the “Auto Follow” button 415 and the “Network Status” indicator 410.

Next on the screen is the “show flow grid” 324 comprising of the plurality of columns 325 and rows 326. The columns 325 comprising: the “Cue#” column 328, the “Cue Start” column 329, the “Cue Countdown” column 330, the “Timer” column 331, the plurality of “Action” columns 332, the plurality of “User” columns 333, the “Notes Shared” column 334 and the “Notes Private” column 335 and are read-only in the tablet application 201 (FIG. 2B). The “show flow grid” 324 is comprised of the plurality of rows 326 identified by numerals 1, 2, 3 etc. Each row 326 represents one cue 327 in the “show flow grid” 324. Changes to the columns 325 and cues 327 may be made by utilizing the computer software application 200 (FIG. 2A) by means of the computer 100 (FIG. 1). The user of the tablet application 201 (FIG. 2B) may, however edit the private notes 335.

FIG. 8 displays the third implementation of the tablet software application 201 (FIG. 2B) as the graphical user interface (GUI) in Timer Mode 800, to be utilized by means of the tablet 111 (FIG. 1), in accordance with one embodiment.

The “Timer Mode” GUI 800 is the module within which the user is able to view the timer full-screen on the tablet 111 (FIG. 1), while connected to the Stage Manager's computer 100 (FIG. 1) via the wireless network router 114 (FIG. 1). The Stage Manager may set timers for the cues 327 (FIG. 3) which are triggered by means of the “Go” function 407 (FIG. 4) in the “Rehearsal Mode” 400 (FIG. 4) or the “Show Mode” 500 (FIG. 5) and are then displayed in real-time on the tablet 111 (FIG. 1), in “Timer Mode” 800.

The “Timer Mode” GUI 800 includes the upper toolbar with the plurality of shortcuts comprising of the “Back” button 223 and the “Invert” button 801. Selecting the “Back” button 223 returns the user to the initial screen GUI 204 (FIG. 2B). Below the toolbar is the full-screen countdown timer 802 displaying hours, minutes and seconds, for example.

FIG. 9A shows a flowchart summarizing a plurality of functional processes in the computer software application 200 (FIG. 2A), in accordance with one embodiment comprising: an “add cue” function 900, a “remove cue” function 901, and an “edit cue” function 902 in the “Design Mode” 300 (FIG. 3), the “Rehearsal Mode” 400 (FIG. 4) or the “Show Mode” 500 (FIG. 5).

In order to understand a plurality of basic rules of logic comprising an “adding cue” logic 910, a “removing cue” logic 911 and an “editing cue” logic 912 within the framework of the software application 200 (FIG. 2A), the following rules and terminology may be useful. There are a plurality of classifications of cues in this embodiment of the invention, comprising of a “Major Cue” type 903 and a “Minor Cue” type 904. The “Major Cues” 903 also referred to as segments, include the user-defined duration 336 and the “Minor Cues” 904 do not include the user-defined duration 336. The duration 336 of each “Major Cue” 903 may not overlap the duration 336 of another “Major Cue” 904. The durations 336 of the consecutive “Major Cues” 903 must meet with no gaps in time. The “Minor Cue” 904 which occurs within the duration 336 of another “Major Cue” 903 is referred to as an “Associated Minor Cue” 904a. The “Minor Cue” 904 which does not occur within the duration 336 of another “Major Cue” 903 is referred to as an “Unassociated Minor Cue” 904b. The cues 327 (FIG. 3) must always be displayed in chronological order within the “Show Flow Grid” 324 (FIG. 3) as determined by the “Cue Start Time” 329 (FIG. 3) of each cue 327 (FIG. 3) and must never include a negative time associated with the duration 336 (FIG. 3).

In the “Rehearsal Mode” 400 (FIG. 4) and in the “Show Mode” 500 (FIG. 5) there are a plurality of states within which the cues 327 (FIG. 3) may exist comprising, a “Current Cue” 905, a “Past Cue” 906 or a “Future Cue” 907. The “Current Cue” 905 is the cue in the “Current Cue Row” position 412. The “Future Cues” 907 include the cue in the “Standby Cue Row” position 413 and any other cue with it's “Cue Start Time” 329 (FIG. 3) occurring after the “cue start time” 329 (FIG. 3) of the “Current Cue” 905. The “Past Cues” 906 include any cue with it's “cue start time” 329 (FIG. 3) occurring before the “cue start time” 329 (FIG. 3) of the “Current Cue” 905.

In “Design Mode” 300 (FIG. 3), any cue 327 (FIG. 3) may be added, removed or edited. To add a cue 327 (FIG. 3) in “Design Mode” 300 (FIG. 3), the user selects from the plurality of “add cue” functions 900 such as the “Cue+” shortcut 312 (FIG. 3) or the “Quick Cue” shortcut 311 (FIG. 3) in the “Design Mode” toolbar 304 or may select the “insert cue” command in the dropdown menu 301. Next, the user may select from the plurality of cue classifications comprising, the “Major Cue” 903 or the “Minor Cue” 904. When adding the “Major Cue” 903, the user must input the “cue start time” 329 (FIG. 3) and the duration 336 (FIG. 3) of the new cue 327 (FIG. 3). When adding the “Minor Cue” 904, the user must input the “cue start time” 329 (FIG. 3) of the new cue 327 (FIG. 3).

To remove cues in “Design Mode” 300 (FIG. 3), the user selects from the plurality of “remove cue” functions 901 such as the “Cue-” shortcut 313 (FIG. 3) in the “Design Mode” toolbar 304 (FIG. 3) or may select the “remove cue” command in the dropdown menu 301 (FIG. 3).

To edit cues in the “Design Mode” 300 (FIG. 3), the user selects from a plurality of “edit cue” functions 902 comprising, clicking on the corresponding “cue start time” column 329 (FIG. 3) to edit the cue start time 329 (FIG. 3) or duration 336 (FIG. 3), clicking on the “format font” function 317 (FIG. 3) to edit the font type, font size or font color, clicking the “highlight selection” function 316 (FIG. 3) to highlight the selected text, for example. When adding “Major Cues” 903, the user must input the “cue start time” 329 (FIG. 3) and duration 336 (FIG. 3) of the new cue and select “maintain cue order” 908 or “change cue order” 909 option. When adding a “Minor Cue” 904, the user must input the “cue start time” 329 (FIG. 3) of the new cue 327 (FIG. 3).

In “Rehearsal Mode” 400 (FIG. 4) the “Past Cues” 906, the “Future Cues” 907 or the “Current Cue” 905 may be added, removed or edited in the Preview & Edit Panel 419.

In the “Show Mode” 500 (FIG. 5), only “Future Cues” 907 may be added, removed or edited. To add, remove or edit the “Current Cue” 905 or the plurality of “Past Cues” 906, the user may click on the “Oops” button 506 (FIG. 5) to recall the “Current Cue” 905 back to the “Standby Cue” position 413. The action may be repeated as many times as desired to recall multiple cues.

In the “Rehearsal Mode” 400 (FIG. 4) and the “Show Mode” 500 (FIG. 5), in order to add, remove or edit cues, the user must first click on the “Edit” button 417 (FIG. 4) in the “Preview & Edit” toolbar 414 (FIG. 4). Once the “Edit” button 417 (FIG. 4) has been enabled, the user is able to access the plurality of buttons and shortcuts in the “Preview & Edit” toolbar 414 (FIG. 4) and make changes to the “Show Flow Grid” 324 (FIG. 4). After the desired changes have been made by the user, the user must click on the “Push/Save” button 418 (FIG. 4) to exit the “Preview & Edit” toolbar 414 (FIG. 4) as well as to save changes to the show flow file and to push changes to connected tablets.

To add cues in the “Rehearsal Mode” 400 (FIG. 4) or the “Show Mode” 500 (FIG. 5), the user selects from the plurality of “add cue” functions 900 such as the “Cue+” shortcut 312 (FIG. 4) or the “Quick Cue” shortcut 311 (FIG. 4) in the “Preview & Edit” toolbar 304 (FIG. 4) or may select the “insert cue” command in the dropdown menu 301 (FIG. 4). Next, the user may add the “Major Cue” 903 or the “Minor Cue” 904. When adding “Major Cues” 903, the user must input the “cue start time” 329 (FIG. 4) and the duration 336 (FIG. 4) of the new cue 327 (FIG. 4). When adding “Minor Cues” 904, the user must input the “cue start time” 329 (FIG. 4) of the new cue 327 (FIG. 4).

To remove cues in the “Rehearsal Mode” 400 (FIG. 4) or the “Show Mode” 500, the user selects from the plurality of “remove cue” functions 901 such as the “Cue-” shortcut 313 (FIG. 4) in the “Preview & Edit” toolbar 414 (FIG. 4) or may select the “remove cue” command in the dropdown menu 301 (FIG. 4).

To edit cues in the “Rehearsal Mode” 400 (FIG. 4) or the “Show Mode” 500, the user selects from the plurality of “edit cue” functions 902 for example, by clicking on the corresponding “cue start time” 329 (FIG. 4) within the “Show Flow Grid” 324 (FIG. 4). When adding the “Major Cues” 903, the user must input the “cue start time” 329 (FIG. 4) and the duration 336 (FIG. 4) of the new cue 327 (FIG. 4) and select a “maintain cue order” function 908 or a “change cue order” function 909. When adding “Minor Cues” 904, the user must input the “cue start time” 329 (FIG. 4) of the new cue 327 (FIG. 4).

Based upon the user-defined inputs and the predetermined logic programmed within the software application 200 (FIG. 2A), the corresponding cue 327 (FIG. 4) is added to 913, removed from 914 or edited within 915 the “Show Flow Grid” 324 (FIG. 4) and the “cue start time” 329 (FIG. 4) and, or the duration 336 (FIG. 4) of other cues 327 (FIG. 4) as well as the corresponding countdown clocks and timers are automatically updated.

In addition to editing the “cue start time” 329 (FIG. 4) and, or duration 336 (FIG. 4) of cues 327 (FIG. 4), the user may edit the text within the “Show Flow Grid” 324 (FIG. 4), highlight 316 (FIG. 4), format font 317 (FIG. 4), rename column labels 916 (FIG. 4) and view and edit expanded text with the “More Info +” indicator 337 (FIG. 3).

FIG. 9B shows a flowchart summarizing the plurality of timers in the computer software application 200 (FIG. 2A), in accordance with one embodiment. The user may add timers in the “Design Mode” 300 (FIG. 3), in the “Preview & Edit Panel” 419 (FIG. 4) of “Rehearsal Mode” 400 (FIG. 4), or in the “Preview & Edit Panel” 419 (FIG. 5) of “Show Mode” 500 (FIG. 5).

The Total Run Time of the show or the “Show TRT” 308 is the industry standard term referring to the measurement of time which the show is expected to run. The user may input the “Show Start Time” 306 and the “Show End Time” 307 in “Design Mode” 300 (FIG. 3) and the software application 200 (FIG. 2A) applies a logic 917a to calculate the “Show TRT” (Total Run Time) 308. The logic 917a correlating to the “Show TRT” 308 is a mathematical formula that is equal to the difference in time between the “Show Start Time” 306 and the “Show End Time” 307 and is displayed in hours, minutes, and seconds, for example.

The “Cue Countdown” 330 counts down the hours, minutes and seconds until the start of the next cue. Each time the user inputs the “Cue Start Time” 329, the software application 200 (FIG. 2A) applies the logic 917b to calculate the “Cue Countdown” 330. The logic 917b correlating to the “Cue Countdown” 330 is a mathematical formula that is equal to the difference in time between the “Cue Start Time” 329 (FIG. 3) of the respective cue 327 (FIG. 3) and the “Cue Start Time” 329 of the next consecutive cue 327 (FIG. 3). Further logic 917b correlating to “Cue Start Time” 329 is illustrated in more detail in FIG. 9A.

The “Duration” 336 is the industry standard term referring to the measurement of time that the cue is expected to run. The user may input the “Duration” 336 and the software application 200 (FIG. 2A) applies the logic 917c and then displays the “Duration” 336 in the Show Flow Grid 324 (FIG. 3). The logic 917c correlating to the “Duration” 336 is illustrated in more detail in FIG. 9A.

The “Timer” 331a is an optional countdown clock that counts down in hours, minutes and seconds, for example from a predetermined input. The user may input the “Timer” 331a and the software application 200 (FIG. 2A) applies the logic 917d and then displays the “Timer” 331a in the plurality of “Timer” outputs 405 as well as any connected tablets displaying the “Timer” GUI 800 (FIG. 8). The logic 917d correlating to the “Timer” 331a determines if there are previous “Timers” 331a still counting down and replaces it once the user clicks the “Go” button 407 (FIG. 4) for the cue 327 (FIG. 3) with another “Timer” 331a preset.

The “Stopwatch” 331b is the optional clock that counts up from zero in hours, minutes and seconds from the predetermined input. The user may input the “Stopwatch” 331b and the software application 200 (FIG. 2A) applies the logic 917e and then displays the “Stopwatch” 331b in the “Stopwatch” output 406. The logic 917e correlating to the stopwatch determines if there are previous “Stopwatches” 331b still counting up and replaces it once the user clicks the “Go” button 407 (FIG. 4) for the cue 327 (FIG. 3) with another “Stopwatch” 331b preset. The “Timer” also has manual override options including pause, resume and reset, for example.

FIG. 9C shows a flowchart summarizing the functional processes relating to advancing cues and activating timers in the “Rehearsal Mode” 400 (FIG. 4) and the “Show Mode” 500 (FIG. 5) including the “Jump to Cue” function 309, the “Find Text” function 310, the “Pause” function 408a, the “Resume” function 408b, the “Reset” function 409, the “Go” function 407, the “Oops” function 506, the “Restart Show” function 414 and the “Auto Follow” function 415.

In the “Rehearsal Mode” 400 (FIG. 4), the user may advance cues 327 (FIG. 4) in any order. In the “Show Mode” 500 (FIG. 5), the user advances cues 327 (FIG. 5) in consecutive order. When the user selects the “Rehearsal Mode” 400 (FIG. 4) or the “Show Mode” 500 (FIG. 5), the first cue is displayed in the “Standby Cue Row” 413 (FIG. 4) and the “Current Cue Row” 412 (FIG. 4) is empty. Once the user clicks the “Go” button 407 (FIG. 4), the corresponding timers are in an activated state 922 and the cue 327 (FIG. 4) in the “Standby Cue Row” 413 (FIG. 4) moves to the “Current Cue Row” 412 (FIG. 4) and the second cue moves to the “Standby Cue Row” 413 (FIG. 4). If “Auto Follow” 415a is on, the third cue then moves to the top of the “Show Flow Grid” 324 (FIG. 4) in the “Preview & Edit Panel”419 (FIG. 4). If “Auto Follow” 415b is off, there is no movement in the “Show Flow Grid” 324 (FIG. 4).

In the “Rehearsal Mode” 400 (FIG. 4), the user may choose to advance cues out of order for the purpose of rehearsing select cues by selecting the “Jump to Cue” function 309 (FIG. 4) or the “Find Text” function 310 (FIG. 4). Once the user inputs the cue number into the “Jump to Cue” input 309 (FIG. 4) or inputs text to search in the “Find Text” input 310 (FIG. 4), there is no change to corresponding timers 918 and the cue with the first occurrence of the search results moves to the “Standby Cue” position 413a and there is no change to the “Current Cue” 412a position. If “Auto Follow” 415a is on, the next consecutive cue after the “Standby Cue” 413 (FIG. 4) moves to the top cue position of the “Show Flow Grid” 324 (FIG. 4) and all other cues in the “Show Flow Grid” 324 (FIG. 4) maintain consecutive cue 327 order.

Selecting the “Pause” button 408a in “Rehearsal Mode” 400 (FIG. 4) pauses the corresponding timers 919 and maintains the “Current Cue” 412b position and the “Standby Cue” 413b position. There is no change to the position of the cues in “Show Flow Grid” 324 (FIG. 4). Once the user clicks on the “Resume” button 408b, the timers resume 920 and the “Current Cue” 412c, the “Standby Cue” 413c and the cues in the “Show Flow Grid” 324 (FIG. 4) maintain position.

Selecting the “Reset” button 409 in the “Rehearsal Mode” 400 (FIG. 4) resets the corresponding timers 921 and recalls the “Current Cue” 412c to the “Standby Cue” 413c position and clears the “Current Cue Row” 412c. If the “Auto Follow” 415a is on, the next consecutive cue after the “Standby Cue” 413d moves to the top cue position of the “Show Flow Grid” 324 (FIG. 4) and all other cues in the “Show Flow Grid” 324 (FIG. 4) maintain consecutive cue order. If the “Auto Follow” 415b is off, there is no change to the cue 327 (FIG. 4) positions in the “Show Flow Grid” 324 (FIG. 4).

In the “Show Mode” 500, the user advances the cues 327 (FIG. 5) in consecutive order. If the user makes a mistake by unintentionally clicking the “Go” button 407 (FIG. 5), the user may click the “Oops” button 506 (FIG. 5). Selecting the “Oops” button 506 (FIG. 5) resets the corresponding timers 921, recalls the “Current Cue” 412e to the “Standby Cue” 413e position and the previous consecutive cue moves to the “Current Cue” 412e position. If the “Auto Follow” 415a is on, the next consecutive cue after the “Standby Cue” 413e moves to the top cue position of the “Show Flow Grid” 324 (FIG. 5) and all other cues in the “Show Flow Grid” 324 (FIG. 5) maintain consecutive cue order. If the “Auto Follow” 415b is off, there is no change to cue 327 (FIG. 5) positions in the “Show Flow Grid” 324 (FIG. 5).

In the “Show Mode” 500, the user may decide to select a “restart show” function 420 from the “dropdown menu” 301 (FIG. 5). Selecting the “restart show” option 420 resets the corresponding timers 921, moves the first cue to the “Standby Cue” position 413f, clears the “Current Cue Row” 412f and moves the second cue to the top cue position of the “Show Flow Grid” 324 (FIG. 5) while other cues in the “Show Flow Grid” 324 (FIG. 5) maintain consecutive cue order. The “Auto Follow” 415a is set to the on position by default when starting or restarting the show.

### ADVANTAGES

The first embodiment of the invention provides many advantages to the event production industry considering the limitations of the current industry standards in regards to event production documents created in static spreadsheet form and stand-alone countdown clocks.

a.) The plurality of built-in timers of the first embodiment comprising of countdown timers, stopwatches, +/− clock, and cue countdown, provides valuable information to the production team and other associated event professionals which they would not have using the current industry standard static show flows printed on paper.

b.) The current and standby cue display of the first embodiment informs all connected users which cue is currently being executed and which cue is next to be executed. Team members no longer have to ask “where are we” on the communication headset which causes excess traffic on the communication channel and could potentially interrupt the Stage Manager and cause confusion among the production team.

c.) The preview & edit, preview, and the auto follow features of the first embodiment allows users to look ahead in the event production document without losing their place. If the production team were using a paper copy of the show flow instead, each time they look ahead to subsequent pages they could potentially lose their place and be confused in regards to upcoming cues which could result in costly user errors.

d.) The integrated countdown timer of the first embodiment allows for full screen functionality to a connected computing device, which is preset by the Stage Manager and is automatically triggered when advancing the cues. This eliminates the need for an additional production crew member to manually manage the prior art countdown timer throughout the event production. The integrated countdown timer in the first embodiment also is displayed on all connected computing devices which communicates the important countdown information to the entire production team and other event professionals, whereas the prior art countdown timer is commonly placed on the lectern on stage for the speaker or presenter and is not visible to the production team and other interested parties. The integrated countdown timer could also be routed to external monitors and placed in the greenroom, for example so that the upcoming presenters could be informed of the time remaining for the current presenter's segment. This would improve the backstage operations compared to current industry standards.

e.) The integrated stopwatch of the first embodiment allows the user to preset a stopwatch function, which may be triggered automatically as the user advances cues. This allows the user to focus on managing the event production and avoid being distracted by having to manually set a separate stopwatch each time it is needed.

f.) The preview & edit function of the first embodiment facilitates valuable real-time updates of the event production documents to the production team while saving time and eliminating potentially costly human errors. Without the real-time updates, it would take more time to make changes to the show flow, print new copies of the show flow, distribute the paper copies to the production team and then for the production team to hand write their personal notes on the paper copies of the show flow. Once the event production is underway, it is impractical to print and distribute updated paper copies and changes are typically made verbally over headset, which could also be a source of costly human errors.

g.) The private notes feature of the first embodiment allows the users to add their own notes digitally without having to hand write notes again and again on each reprinted paper version of the event production documents. This saves valuable time and reduces the chance for human error.

h.) The integrated print function of the first embodiment allows users to print event production documents or show flows with all of the columns or to select a user specific show flow, which includes predetermined columns. This saves time as the Stage Manager doesn't have to print show flows for every user and the users may print a more customized show flow that doesn't include information which does not pertain to them.

### CONCLUSION, RAMIFICATIONS AND SCOPE

In conclusion, the digital show flow with integrated timers and connectivity to other computing devices of the first embodiment of the invention has many advantages as compared to current industry standard event production documents, which are generally created as spreadsheets then printed on paper, revised and reprinted up until show time. Once the show begins, the Stage Manager verbally calls changes to the show flow over the communication headset system. The ability to share real-time updates with connected computing devices in the first embodiment may reduce human errors and significantly save time and money associated with the live event production.

It is noted that the first implementation of the invention is described within the context of the familiar MacBook Pro laptop computer and iPads, however, different types of computer processing devices such as desktop computers, laptop computers, tablet computing devices and other portable hand-held computing devices with different hardware, software, operating systems and other specifications may be used for various embodiments of the invention. Alternative embodiments may also utilize a plurality of monitors, screens, printers, keyboards and other input devices.

The wired and network connections shown in the first embodiment of the invention are exemplary and other means of establishing communications with other devices or storage means such as a local wired or wireless network or via the Internet may also be used.

Alternative embodiments may comprise of different modes, which may function independently or cooperatively and may operate with or without connecting to other computing devices. Alternative embodiments may also comprise of native software applications for different operating systems or web-based software as a service, for example.

Alternative embodiments of the invention may include a plurality of customization options comprising of changing column width, changing row height, highlighting rows or columns, adding or removing columns, changing column order, formatting font style, formatting font size, formatting font color, and bold or italicized font, for example.

Other implementations of the invention may allow the plurality of computing devices to select which combination of columns to view including the option to view individual or multiple users columns at one time and to change the layout on the screen to suit personal preferences.

Other implementations of this invention may include different methods for controlling functionality such as: dragging and dropping the rows or columns by means of right clicking or double tapping rows, columns, cells, buttons and, or shortcuts with a mouse, track pad or touch screen, or voice controlled functionality, for example. Other remote control devices may also be implemented to control functionality of the first embodiment of the invention by means of other computers, tablets, phones, clickers, keypads or other mechanical or digital control devices.

Alternative embodiments of the invention may include integrated instant messaging, text messaging or SMS messaging between users of a plurality of computing devices. Predetermined messages could be associated with specific cues and automatically triggered to send to a user on their device when advancing to the specific cue in the show flow. This could be used to alert a presenter that they should be ready back stage at a predetermined time, for example. Other automatic triggers could function as a show control to automatically turn lights on or off, switch video sources, play a video, fade music up or down, change songs, turn microphones on or off, lower or raise drapery, cue talent or presenters with lights, for example.

There are various possibilities with regard to the integrated timer of the first implementation of the invention. The timer could be customized with various fonts types, font sizes, colors, and highlights or with different color or style background images. Alternative embodiments of the timer could integrate the countdown clock, stopwatch, various alphanumeric text or symbols. The timer could also integrate an instant messaging function to be able to communicate with the presenter or talent while on stage, for example. The timer could be displayed on a tablet or other computing device and could be controlled by a plurality of computing devices.

Alternative embodiments of the invention may include the ability to create, edit, save, open, view, annotate, resize, print and share a plurality of file types comprising of .sho, .xls, .xlsx, .doc, .docx, .pdf, for example. The various file types may also be integrated into the event production documents as 6-ups, scripts, previews, graphics and videos, for example.

Alternative embodiments of the invention may include opening, saving, editing, printing and sharing files from a plurality of computing devices. Other implementations of this invention may include saving the private notes function locally on the computing device, remotely on another computing device or remote storage means such as a cloud-based storage system.

The first embodiment of the invention may be used in association with many different types of events productions such as corporate meetings, broadcast television, concerts, sporting events, live theater, manufacturing, medical procedures or education, for example.

While the above description contains many specificities, these should not be construed as limitations on the scope of any embodiment, but as exemplifications of various embodiments. Thus, the scope should be determined by the appended claims and their legal equivalents, and not solely by the examples given.

1. A data processing system for managing an event production, said data processing system comprising:
a. an interface means for inputting a plurality of data;
b. a computer processor means for processing said data;
c. a storage means for storing said data on a storage medium;
d. a retrieval means for retrieving said data;
e. a display means for displaying said data;
wherein, said system produces a plurality of event production documents for managing said event production.

2. The data processing system of claim 1, further comprising:
a. a connection means for connecting a plurality of computing devices to said data processing system;
wherein, said computing devices are configured to create, display, edit, save or share said event production documents.

3. The data processing system of claim 1, further comprising:
a. an interface means for adding said data;
b. an interface means for removing said data;
c. an interface means for editing said data;
d. a plurality of predetermined logic rules for processing said data;
wherein, said predetermined logic rules are associated with real-time changes to corresponding parts of said show flow documents.

4. The interface means of claim 1, further comprising:
a. a first means for designing said event production documents;
b. a second means for rehearsing said event production documents;
c. a third means for executing said event production documents;
wherein, said first means is characterized by creating a plurality of cues in said event production document, said second means is characterized by advancing said cues in any order, said third means is characterized by advancing said cues in chronological order and the plurality of said means may function independently or cooperatively.

5. The interface means of claim 1, further comprising:
a. a first means for previewing said event production documents;
b. a second means for editing said event production documents;
wherein, said first means is characterized by a dynamic user interface and second means is associated with a plurality of predetermined logic rules.

6. The display means of claim 1, further comprising:
a. a means for displaying a plurality of timers;
wherein, said timers are associated with said data processing system and are characterized by a plurality of predetermined logic rules.

7. A method for generating a plurality of event production documents, said method comprising:
a. providing a first input means for inputting a plurality of data;
b. providing a second processing means for processing said data;
c. providing a third storage means for storing said data on a storage medium;
d. providing a fourth retrieval means for retrieving said data;
e. providing a fifth display means for displaying said data;
whereby, said event production documents are characterized by a plurality of user-defined cues.

8. The method of claim 7, further comprising:
a. adding said data associated with said cues;
b. removing said data associated with said cues;
c. editing said data associated with said cues;
whereby, said data may be processed according to a plurality of predetermined logic rules resulting in corresponding changes to said cues and said event production documents.

9. The method of claim 7, further comprising:
a. connecting to a plurality of computing devices;
b. viewing said event production documents on said computing devices;
whereby, changes to said event production documents are viewable on said computing devices in real-time.

10. The method of claim 7, further comprising:
a. providing a user interface for rehearsing said cues;
b. connecting to a plurality of computing devices;
c. advancing said cues in any order;
d. editing said cues in said user interface;
e. correlating changes to said cues in real-time on said computing devices;
whereby, said cues may be edited according to a plurality of predetermined logic rules resulting in corresponding changes to said cues and said event production documents.

11. The method of claim 7, further comprising:
a. providing a user interface for executing said cues;
b. connecting to a plurality of computing devices;
c. advancing said cues in chronological order;
d. editing said cues in said user interface;
e. correlating changes to said cues in real-time on said computing devices;
whereby, said cues may be edited according to a plurality of predetermined logic rules resulting in corresponding changes to said cues and said event production documents.

12. A data processing system for generating a plurality of event production documents, said data processing system comprising:
a. an interface means for inputting a plurality of data;
b. a processor means for processing said data;
c. a storage means for storing said data on a storage medium;
d. a retrieval means for retrieving said data associated with said storage medium;
e. a display means for viewing said data;
wherein, said data is processed by said data processing system according to a plurality of predetermined logic rules.

13. The data processing system of claim 12, further comprising:
a. a user interface for adding data associated with said event production documents;
wherein, said user interface includes a plurality of user-defined inputs characterized by a cue start time or a duration.

14. The data processing system of claim 12, further comprising:
a. a user interface for adding data associated with said event production documents;
wherein, said user interface is characterized by a plurality of predetermined settings which may facilitate adding said data to said event production document by means of a minimum of a single action.

15. The plurality of predetermined logic rules of claim 12, further comprising:
a. a first logic rule configured to delineate a plurality of cue numbers;
b. a second logic rule configured to delineate a plurality of major cues;
c. a third logic rule configured to delineate a plurality of minor cues;
d. a fourth logic rule configured to delineate a plurality of associated minor cues;
e. a fifth logic rule configured to delineate a plurality of unassociated minor cues;
f. a sixth logic rule configured to allocate a plurality of durations to corresponding said major cues;
g. a seventh logic rule configured to allocate a plurality of start times to corresponding said major cues;
h. an eighth logic rule configured to allocate a plurality of start times to corresponding said minor cues;
i. a ninth logic rule configured to not allow said durations of said major cues to overlap;
j. a tenth logic rule configured to to require said durations of said major cues to meet without gaps;
k. an eleventh logic rule configured to maintain chronological order of said cue start times;
l. a twelfth logic rule configured to maintain numerical order of cue numbers;
m. a thirteenth logic rule configured to not allow said durations to be associated with negative measurements of time;
n. a fourteenth logic rule configured to not allow a plurality of cues to have the exact same start time.
wherein, said logic rules may operate independently or in cooperation with each other.

16. The data processing system of claim 12, further comprising:
a. a second interface means for viewing said data;
wherein, said second interface means is characterized by previewing and editing of said data.

17. The data processing system of claim 12, further comprising:
a. a third interface means for viewing said data;
wherein, said third interface means is characterized by a current cue and a standby cue.

18. The data processing system of claim 12, further comprising:
a. a current and standby cue interface;
b. a preview and edit interface;
c. a first means for advancing a plurality of cues;
d. a second means for auto following said cues;
wherein, said cues are advanced within said preview and edit interface in association with said first means for advancing said cues and a plurality of following cues are advanced within said preview and edit interface in association with said second means for auto following said cues.

19. The data processing system of claim 12, further comprising:
a. a first total run time calculation;
b. a second cue countdown calculation;
c. a third timer countdown calculation;
d. a fourth stopwatch calculation;
e. a fifth +/− scheduled time calculation;
wherein, said calculations are based on a plurality of predetermined logic rules.

20. The data processing system of claim 12, further comprising:
a. a digital timer output;
b. wherein, said digital timer output is associated with said event production document and is triggered according to a set of predetermined logic rules.
